(19) United States
(12) Patent Application Publication
(10) Pub. No.: US 2026/0303779 A1
(43) Pub. Date: Oct. 1, 2026

(54) VIDEO ENCODING METHOD AND APPARATUS, VIDEO DECODING METHOD AND APPARATUS, COMPUTER-READABLE MEDIUM, AND ELECTRONIC DEVICE

(71) Applicant: Tencent Technology (Shenzhen) Company Limited, Shenzhen (CN)

(72) Inventors: Yingbin Wang, Shenzhen (CN); Xiaozhong Xu, Shenzhen (CN)

(21) Appl. No.: 19/697,013

(22) Filed: Jun. 3, 2026

Related U.S. Application Data
(63) Continuation of application No. PCT/CN2024/131393, filed on Nov. 11, 2024.

(30) Foreign Application Priority Data
Dec. 12, 2023 (CN) 202311706064.9

(51) Int. Cl. H04N 19/103; H04N 19/139; H04N 19/176; H04N 19/513; H04N 19/70

(52) U.S. Cl. CPC H04N 19/103; H04N 19/139; H04N 19/176; H04N 19/513; H04N 19/70

(57) ABSTRACT

Embodiments of this application provide a video encoding/decoding method performed by an electronic device. The video decoding method includes: decoding a video code stream, to obtain mode index information for a rearranged mode list; sorting a plurality of angular weighted prediction (AWP) modes used for a current block in accordance with an ascending order of cost of the plurality of AWP modes, to obtain the rearranged mode list; selecting a corresponding AWP mode from the rearranged mode list based on the mode index information; deriving a weight matrix of the current block based on the selected AWP mode; and performing weighted prediction based on the weight matrix, to obtain a predicted value corresponding to the current block. Through technical solutions in the embodiments of this application, encoding bit overheads of AWP mode index information can be effectively reduced, helping improve encoding and decoding performance.

### CROSS-REFERENCE TO RELATED APPLICATIONS

This application is a continuation application of PCT Patent Application No. PCT/CN2024/131393, entitled “VIDEO ENCODING METHOD AND APPARATUS, VIDEO DECODING METHOD AND APPARATUS, COMPUTER-READABLE MEDIUM, AND ELECTRONIC DEVICE” filed on Nov. 11, 2024, which claims priority to Chinese Patent Application No. 202311706064.9, entitled “VIDEO ENCODING METHOD AND APPARATUS, VIDEO DECODING METHOD AND APPARATUS, COMPUTER-READABLE MEDIUM, AND ELECTRONIC DEVICE” and filed with the China National Intellectual Property Administration on Dec. 12, 2023, which is incorporated herein by reference in its entirety.

### FIELD OF THE TECHNOLOGY

This application relates to the field of computer and communication technologies, and in particular, to a video encoding method and apparatus, a video decoding method and apparatus, a computer-readable medium, and an electronic device.

### BACKGROUND OF THE DISCLOSURE

In related audio and video standards (for example, a second stage of AVS3), an angular weighted prediction (AWP) technology and a spatial angular weighted prediction (SAWP) technology are used. These prediction technologies use a weight mask to perform weighting on two prediction blocks, to combine different parts of the prediction blocks. However, for a coding block using the AWP technology, a mode index needs to be encoded in a code stream. The mode index may determine a reference weight configuration and a weight prediction angle required for deriving a weight matrix. Currently, 56 AWP modes are supported in the AVS3, and coding these mode indexes in the code stream has relatively large bit overheads.

### SUMMARY

Embodiments of this application provide a video encoding method and apparatus, a video decoding method and apparatus, a computer-readable medium, and an electronic device, which can effectively reduce encoding bit overheads of angular weighted prediction (AWP) mode index information, and help improve encoding and decoding performance.

Other features and advantages of this application become apparent through the following detailed descriptions or partially learned through practice of this application.

According to one aspect of the embodiments of this application, a video decoding method is provided, including: decoding a video code stream, to obtain mode index information for a rearranged mode list; sorting a plurality of angular weighted prediction (AWP) modes used for a current block in accordance with an ascending order of cost of the plurality of AWP modes, to obtain the rearranged mode list; selecting a corresponding AWP mode from the rearranged mode list based on the mode index information; deriving a weight matrix of the current block based on the selected AWP mode; and performing weighted prediction based on the weight matrix, to obtain a predicted value corresponding to the current block.

According to one aspect of the embodiments of this application, a video encoding method is provided, including: sorting, in ascending order of costs of a plurality of AWP modes used for a current block, the plurality of AWP modes, to obtain the rearranged mode list; determining mode index information based on the rearranged mode list and a selected AWP mode; deriving a weight matrix of the current block based on the selected AWP mode; and performing weighted prediction based on the weight matrix, to obtain a predicted value corresponding to the current block, performing encoding processing on the current block based on the predicted value, and encoding the mode index information in a video code stream.

According to one aspect of the embodiments of this application, a video decoding apparatus is provided, including: a decoding unit, configured to decode a video code stream, to obtain mode index information for a rearranged mode list; a sorting unit, configured to sort, in ascending order of costs of a plurality of AWP modes used for a current block, the plurality of AWP modes, to obtain the rearranged mode list; a selection unit, configured to select a corresponding AWP mode from the rearranged mode list based on the mode index information, and derive a weight matrix of the current block based on the selected AWP mode; and a processing unit, configured to perform weighted prediction based on the weight matrix, to obtain a predicted value corresponding to the current block.

According to one aspect of the embodiments of this application, a video encoding apparatus is provided, including: a sorting unit, configured to sort, in ascending order of costs of a plurality of AWP modes used for a current block, the plurality of AWP modes, to obtain the rearranged mode list; a determining unit, configured to determine mode index information based on the rearranged mode list and a selected AWP mode; a calculation unit, configured to derive a weight matrix of the current block based on the selected AWP mode; and a coding unit (CU), configured to perform weighted prediction based on the weight matrix, to obtain a predicted value corresponding to the current block, perform encoding processing on the current block based on the predicted value, and encode the mode index information in a video code stream.

According to one aspect of the embodiments of this application, a non-transitory computer-readable medium is provided, having a computer program stored therein, the computer program, when executed by a processor of an electronic device, causing the electronic device to implement the method according to the foregoing embodiments.

According to one aspect of the embodiments of this application, an electronic device is provided, including: one or more processors; and a storage apparatus, configured to store one or more computer programs, the one or more computer programs, when executed by the one or more processors, causing the electronic device to implement the method according to the foregoing embodiments.

According to one aspect of the embodiments of this application, a computer program product is provided, the computer program product including a computer program, and the computer program being stored in a computer-readable storage medium. A processor of an electronic device reads the computer program from the computer-readable storage medium and executes the computer program, so that the electronic device performs the method provided in the foregoing exemplary embodiments.

In technical solutions provided in some embodiments of this application, the video code stream is decoded to obtain mode index information of the rearranged mode list, the AWP modes are sorted in ascending order of costs of using the plurality of AWP modes by the current block, to obtain the rearranged mode list, and then the corresponding AWP mode is selected from the rearranged mode list based on the mode index information, so that the AWP mode with a relatively high probability of being selected (namely, a relatively low cost) has a smaller index value in the rearranged mode list, thereby effectively reducing coding bit overheads of the AWP mode index information and helping improve encoding and decoding performance.

The foregoing general descriptions and the following detailed descriptions are merely for illustration and explanation purposes and are not intended to limit this application.

### BRIEF DESCRIPTION OF THE DRAWINGS

FIG. 1 is a schematic diagram of an exemplary system architecture to which technical solutions of embodiments of this application are applicable;

FIG. 2 is a schematic diagram of an arrangement mode of a video encoding apparatus and a video decoding apparatus in a streaming transmission system;

FIG. 3 is a basic flowchart of a video coder;

FIG. 4 is a schematic diagram of a block partition structure in an HEVC standard;

FIG. 5 is a schematic diagram of a block partition structure in an AVS3 standard;

FIG. 6 is a schematic diagram of an angular prediction direction in an intra prediction mode;

FIG. 7 is a schematic diagram of intra prediction;

FIG. 8 is a schematic diagram of inter frame prediction;

FIG. 9 is a schematic flowchart of a prediction process of an angular weighted prediction (AWP) mode;

FIG. 10 is a schematic diagram of 8 weight generation angles;

FIG. 11 is a schematic diagram of 7 predicted positions of a reference weight;

FIG. 12 is a schematic diagram of angle sub-areas of an AWP mode;

FIG. 13 is a flowchart of a video decoding method according to an embodiment of this application;

FIG. 14 is a flowchart of a video encoding method according to an embodiment of this application;

FIG. 15 is a schematic picture diagram of a reference weight derivation function in a form of a sigmoid function according to an embodiment of this application;

FIG. 16 is a schematic picture diagram of a reference weight derivation function based on a form of a hyperbolic tangent function according to an embodiment of this application;

FIG. 17 is a schematic picture diagram of a reference weight derivation function based on a form of a cosine function according to an embodiment of this application;

FIG. 18 is a block diagram of a video decoding apparatus according to an embodiment of this application;

FIG. 19 is a block diagram of a video encoding apparatus according to an embodiment of this application; and

FIG. 20 is a schematic structural diagram of a computer system adapted to implement an electronic device according to an embodiment of this application.

### DESCRIPTION OF EMBODIMENTS

Exemplary implementations are described more comprehensively with reference to drawings. However, the exemplary implementations can be implemented in various forms, and are not to be understood as being limited to examples described herein. Rather, an objective of providing these implementations is to make this application more comprehensive and complete, and to comprehensively convey the concept of the exemplary implementations to a person skilled in the art.

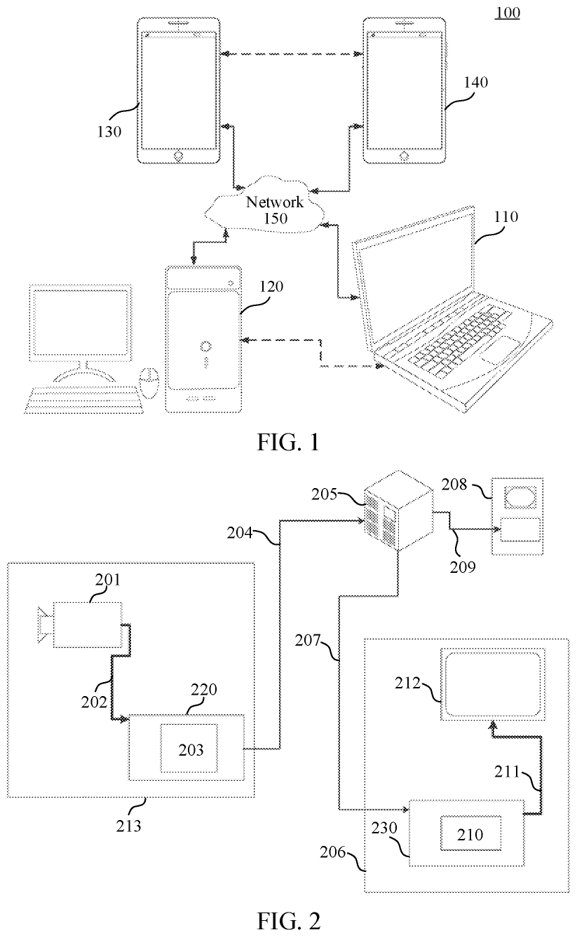

FIG. 1 is a schematic diagram of an exemplary system architecture to which technical solutions of embodiments of this application are applicable.

As shown in FIG. 1, a system architecture 100 includes a plurality of terminal apparatuses. The terminal apparatuses may communicate with each other through, for example, a network 150. For example, the system architecture 100 may include a first terminal apparatus 110 and a second terminal apparatus 120 connected through the network 150. In the embodiment of FIG. 1, the first terminal apparatus 110 and the second terminal apparatus 120 perform unidirectional data transmission.

For example, the first terminal apparatus 110 may encode video data (for example, a video picture stream collected by the first terminal apparatus 110) and transmit the encoded video data to the second terminal apparatus 120 through the network 150. The encoded video data is transmitted in a form of one or more encoded video code streams. The second terminal apparatus 120 may receive the encoded video data through the network 150, decode the coded video data to recover the video data, and display a video picture based on the recovered video data.

In an embodiment of this application, the system architecture 100 may include a third terminal apparatus 130 and a fourth terminal apparatus 140 that perform bidirectional transmission of the encoded video data. The bidirectional transmission may be performed, for example, during a video conference. During the bidirectional data transmission, one of the third terminal apparatus 130 and the fourth terminal apparatus 140 may encode video data (for example, a video picture stream collected by a terminal apparatus) and transmit the encoded video data to the other of the third terminal apparatus 130 and the fourth terminal apparatus 140 through the network 150. One of the third terminal apparatus 130 and the fourth terminal apparatus 140 may further receive the encoded video data transmitted by the other of the third terminal apparatus 130 and the fourth terminal apparatus 140, and may decode the encoded video data to recover the video data and may display a video picture on an accessible display apparatus based on the recovered video data.

In the embodiment shown in FIG. 1, the first terminal apparatus 110, the second terminal apparatus 120, the third terminal apparatus 130, and the fourth terminal apparatus 140 may be servers or terminals, but the principles disclosed in this application may not be limited thereto.

The server may be an independent physical server, or may be a server cluster or a distributed system formed by a plurality of physical servers, or may further be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal may be a smartphone, a tablet computer, a notebook computer, a desktop computer, a smart speaker, a smart voice interaction device, a smartwatch, a smart household appliance, an on-board terminal, an aircraft, or the like, but is not limited thereto.

The network 150 shown in FIG. 1 represents any number of networks through which the encoded video data is transmitted among the first terminal apparatus 110, the second terminal apparatus 120, the third terminal apparatus 130, and the fourth terminal apparatus 140, including, for example, a wired and/or wireless communication network. The communication network 150 may exchange data in a circuit-switched and/or packet-switched channel. The network may include a telecommunications network, a local area network, a wide area network, and/or the Internet. For the purpose of this application, unless explained below, an architecture and a topology of the network 150 may be inessential to operations disclosed in this application.

In an embodiment of this application, FIG. 2 shows an arrangement mode of a video encoding apparatus and a video decoding apparatus in a streaming transmission environment. The subject disclosed in this application may be comparably applicable to another application supporting a video, including, for example, a video conference, a digital television (TV), and storage of compressed videos on a digital medium including a CD, a DVD, and a memory stick.

A streaming transmission system may include a collection subsystem 213. The collection subsystem 213 may include a video source 201 such as a digital camera. The video source creates an uncompressed video picture stream 202. In an embodiment, the video picture stream 202 includes a sample captured by the digital camera. Compared with encoded video data 204 (or an encoded video code stream 204), the video picture stream 202 is depicted by using a thick line to emphasize a video picture stream with a high data volume. The video picture stream 202 may be processed by an electronic apparatus 220. The electronic apparatus 220 includes a video encoding apparatus 203 coupled to the video source 201. The video encoding apparatus 203 may include hardware, software, or a combination of hardware and software to implement or execute various aspects of the disclosed subject described in greater detail below. Compared with the video picture stream 202, the encoded video data 204 (or the encoded video code stream 204) is depicted by a thin line to emphasize the encoded video data 204 (or the encoded video code stream 204) with a small data volume, which may be stored in a streaming transmission server 205 for future use. One or more streaming transmission client subsystems, for example, a client subsystem 206 and a client subsystem 208 in FIG. 2, may access the streaming transmission server 205 to retrieve a copy 207 and a copy 209 of the encoded video data 204. The client subsystem 206 may include, for example, a video decoding apparatus 210 in an electronic apparatus 230. The video decoding apparatus 210 decodes an incoming copy 207 of the encoded video data, and generates an output video picture stream 211 that may be presented on a display 212 (for example, a display screen) or another display apparatus. In some streaming transmission systems, the encoded video data 204, the video data 207, and the video data 209 (for example, the video code stream) may be encoded based on some video encoding/compression standards.

The electronic apparatus 220 and the electronic apparatus 230 may include other components not shown in the figure. For example, the electronic apparatus 220 may include a video decoding apparatus, and the electronic apparatus 230 may further include a video encoding apparatus.

In an embodiment of this application, international video encoding standards such as High Efficiency Video Coding (HEVC) and Versatile Video Coding (VVC) and Chinese national video coding standards such as Audio Video Coding Standard (AVS) are used as examples. After a video picture frame is inputted, the video picture frame is partitioned into several non-overlapping processing units based on a block size, and a similar compression operation is performed on each processing unit. The processing unit is referred to as a coding tree unit (CTU) or a largest coding unit (LCU). The CTU may further be partitioned more finely to obtain one or more basic coding units (CU). The CU is a most basic element in a coding process.

In another embodiment, the processing unit may also be referred to as a coding slice (namely, a tile), which is a rectangular area of a multimedia data frame that may be independently decoded and encoded. In the AV1 standard, the coding slice may further be partitioned more finely to obtain one or more largest coding blocks (Superblock, SB for short). The SB is a starting point of block partition, and may further be partitioned into a plurality of sub-blocks, and then the largest coding block is further partitioned to obtain one or more blocks. Each block is a most basic element in a coding process. In one embodiment, one SB may include several blocks.

The foregoing partition mode for a video picture frame may be referred to as a block partition structure. Some concepts in the coding process are described below.

Predictive coding: The predictive coding includes modes such as intra prediction and inter prediction. After an original video signal is predicted through a selected reconstructed video signal, a residual video signal is obtained. A coder end needs to determine a predictive coding mode for a current coding unit (or a coding block) and inform a decoder end. The intra prediction means that a predicted signal comes from an area in the same picture that has been encoded and reconstructed. The inter frame prediction means that the predicted signal comes from another encoded picture (referred to as a reference picture) that is different from a current picture.

Transform & quantization: A residual video signal undergoes a transformation operation such as a Discrete Fourier transform (DFT), and a Discrete Cosine Transform (DCT), to convert a signal into a transform domain, which is referred to as a transform coefficient. A lossy quantization operation is further performed on the transform coefficient, which loses a specific amount of information, so that the quantized signal facilitates compressed expression. In some video encoding standards, more than one transform modes may be selected. Therefore, the coder end also needs to select one of the transform modes for the current coding unit (or the coding block) and inform the decoder end. Fineness of quantization is generally determined by a quantization parameter (QP for short). A larger QP indicates that coefficients within a larger value range are to be quantized to the same output, which usually brings larger distortion and a lower bit rate. On the contrary, a smaller QP indicates that coefficients within a smaller value range are to be quantized to the same output, which usually brings less distortion and a higher bit rate.

Entropy coding or statistical coding: Statistical compression coding is performed on the quantized signal in the transform domain based on a frequency of occurrence of each value, and finally a binarized (0 or 1) compressed code stream is outputted. In addition, entropy coding also needs to be performed on another information generated through coding, such as a selected coding mode and motion vector data, to reduce a bit rate. Statistical coding is a lossless coding manner that can effectively reduce a bit rate required for expressing the same signal. A common statistical coding manner includes variable length coding (VLC for short) or context adaptive binary arithmetic coding (CABAC for short).

A CABAC process mainly includes 3 operations: binarization, context modeling, and binary arithmetic coding. After binarization processing is performed on an input syntax element, binary data may be encoded through a conventional coding mode and a bypass coding mode. In the bypass coding mode, a specific probability model does not need to be allocated to each binary digit, and an input binary digit bin value is directly encoded through a simple bypass coder, to accelerate entire coding and decoding. Generally, different syntax elements are not completely independent of each other, and the same syntax element also has some memorability. Therefore, based on a conditional entropy theory, conditional coding is performed through another coded syntax element, and coding performance can be further improved compared with independent coding or memoryless coding. The encoded symbol information used as a condition is referred to as a context. In a conventional coding mode, binary digits of the syntax element sequentially enter a context modeling device. An encoder allocates an appropriate probability model to each input binary digit based on a value of a syntax element or a binary bit that has been encoded previously. This process is context modeling. A context model corresponding to the syntax element may be positioned through a context index increment (ctxIdxInc) and a context index start (ctxIdxStart). After the bin value and the allocated probability model are both inputted into a binary arithmetic coder for coding, the context model needs to be updated based on the bin value, which is an adaptation process during coding.

Loop filtering: Operations of inverse quantization, inverse transform, and predictive compensation are performed on a transformed and quantized signal to obtain a reconstructed picture. The reconstructed picture has some information different from that in an original picture as a result of quantization, that is, the reconstructed picture has distortion. Therefore, a filtering operation may be performed on the reconstructed picture by using filters such as a deblocking filter (DB for short), a sample adaptive offset (SAO) filter, or an adaptive loop filter (ALF), which can effectively reduce a degree of distortion caused by quantization. Since the filtered reconstructed picture will be used as a reference for subsequently coding pictures so as to predict future picture signals, the above filtering operation is also referred to as loop filtering, namely, a filtering operation in a coding loop.

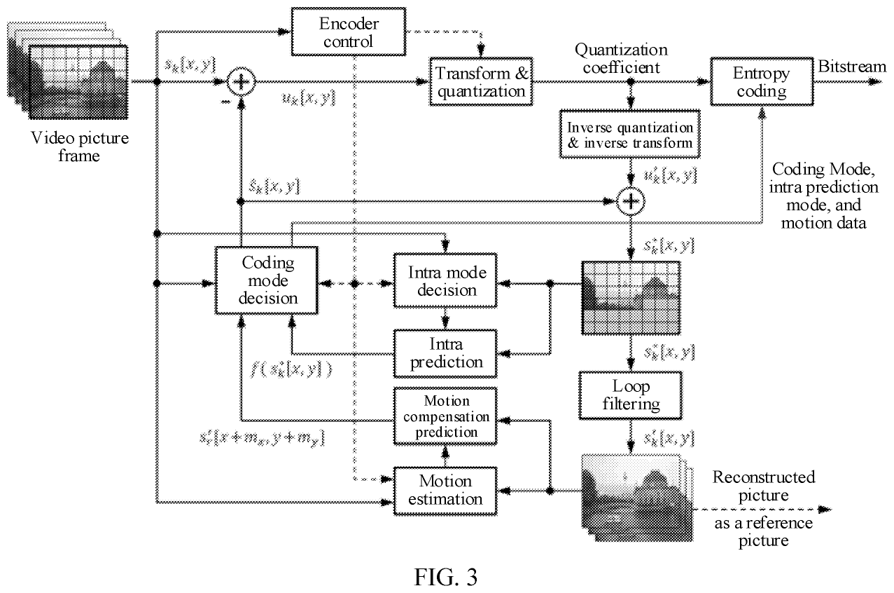

In an embodiment of this application, FIG. 3 is a basic flowchart of a video coder. In this process, intra prediction is used as an example for description. A difference between an original picture signal sₖ[x,y] and a predicted picture signal ŝₖ[x,y] is calculated to obtain a residual signal uₖ[x,y], and the residual signal uₖ[x,y] is transformed and quantized to obtain a quantization coefficient. The quantization coefficient is subjected to entropy coding to obtain an encoded bitstream, and is further subjected to inverse quantization and inverse transform to obtain a reconstructed residual signal u′ₖ[x, y]. The predicted picture signal ŝₖ[x,y] is superimposed with the reconstructed residual signal u′ₖ[x, y] to generate a picture signal sₖ*[x, y]. The picture signal sₖ*[x,y] is inputted to an intra mode decision module and an intra prediction module for intra prediction, and is further subjected to loop filtering to output a reconstructed picture signal s′ₖ[x, y]. The reconstructed picture signal s′ₖ[x,y] may be used as a reference picture for a next frame for motion estimation and motion compensation prediction. Then a predicted picture signal ŝₖ[x, y] of the next frame is obtained based on a result s′ᵣ[x+mₓ, y+m_{y}] of the motion compensation prediction and a result f(sₖ*[x, y]) of the intra prediction. The above process is repeated until the coding is completed.

Based on the foregoing coding process, on the decoder end, for each CU (or a coding block), after a compressed code stream (namely, a bitstream) is obtained, entropy decoding is performed to obtain various mode information and quantization coefficients. Then inverse quantization and inverse transform are performed on the quantization coefficients to obtain a residual signal. In addition, a predicted signal corresponding to the CU (or the coding block) may be obtained based on coding mode information that is known. Then the residual signal and the predicted signal may be added together to obtain a reconstructed signal. The reconstructed signal is then subjected to operations such as loop filtering to generate a final output signal.

Currently, mainstream video encoding standards, such as High Efficiency Video Coding (HEVC), Versatile Video Coding (VVC), AVS3, Alliance for Open Media Video 1 (AV1, a first generation video coding standard developed by the Alliance for Open Media), and Alliance for Open Media Video 2 (AV2, a second generation video coding standard developed by the Alliance for Open Media), all use a block-based hybrid coding framework. Specifically, original video data is partitioned into a series of coding blocks by using the standards, and the video data is compressed by using video encoding methods such as prediction, transform, and entropy coding.

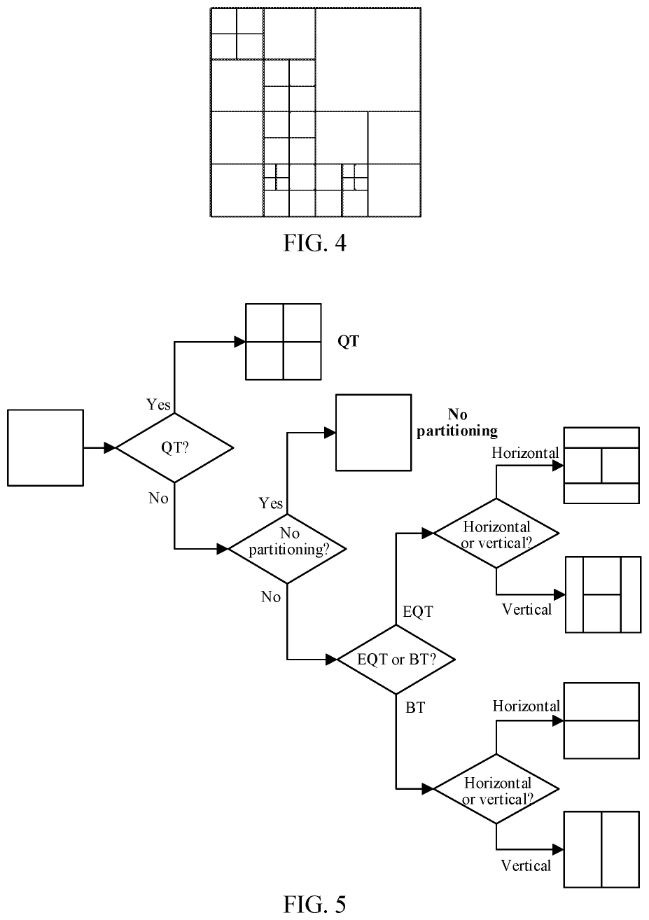

In a hybrid coding framework based on block partition, a video picture is partitioned into several non-overlapping processing units for video compression. The processing unit is referred to as a coding tree unit (CTU). The CTU may be further partitioned more finely to obtain one or more basic coding units, which are referred to as coding units (CU). Each CU is the most basic element in a coding process, and each CU may select a different coding mode. FIG. 4 is a schematic diagram of a block partition structure in the HEVC standard. A CTU may be further partitioned based on a quad-tree (QT) mode.

The AVS3 standard uses a basic block partition structure of a QT+binary-tree (BT)+extended quad-tree (EQT). Specifically, a representation mode of a basic block partition structure of QT+BT+EQT in the AVS3 in a code stream is shown in FIG. 5. For a CU, it is first determined whether the QT is used for partition. If the QT is used, QT partition is directly performed. If the QT is not used, it is further determined whether partition is not performed. If partition is not performed, the process ends. If the partition needs to be performed, it is then determined whether the EQT or the BT is used. In addition, regardless of whether the EQT or the BT is used, horizontal partition or vertical partition needs to be determined. The block partition is to perform recursive partition decision in a top-down mode starting from the LCU. In a recursion process, an optimal partition mode and coding mode are determined by the coder end through optimization.

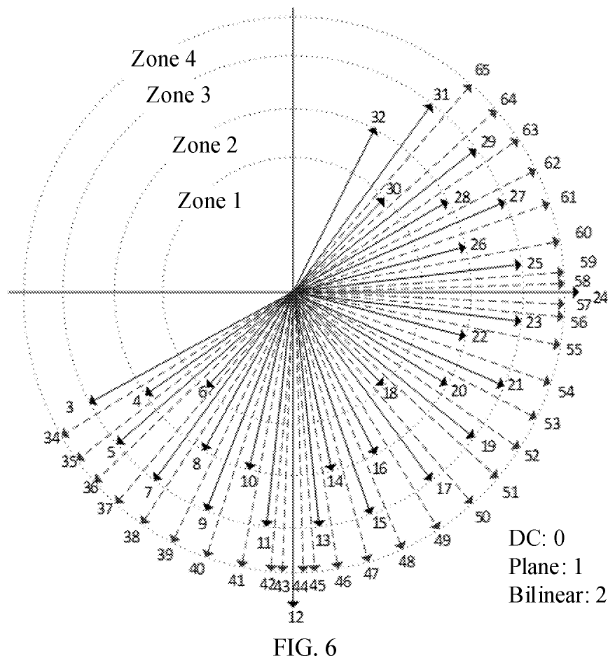

The intra prediction is a common predictive coding technology. The intra prediction derives a predicted value of a current coding block from an adjacent encoded area based on a correlation that exists between pixels of a video picture in a space domain. In the second stage of AVS3, an extended intra prediction mode (EIPM for short) is adopted. The previous generation AVS2 supports 33 intra prediction modes in total, including 30 angular prediction modes and 3 special prediction modes (a plane prediction mode, a DC prediction mode, and a bilinear prediction mode). Coding is performed through 2 most probable modes (MPM), and coding is performed through fixed-length coding of 5 bits in the remaining modes. To support finer angular prediction, the AVS3 extends to support 62 angular prediction modes. As shown in FIG. 6, numbers of newly added angular prediction modes are 34 to 65.

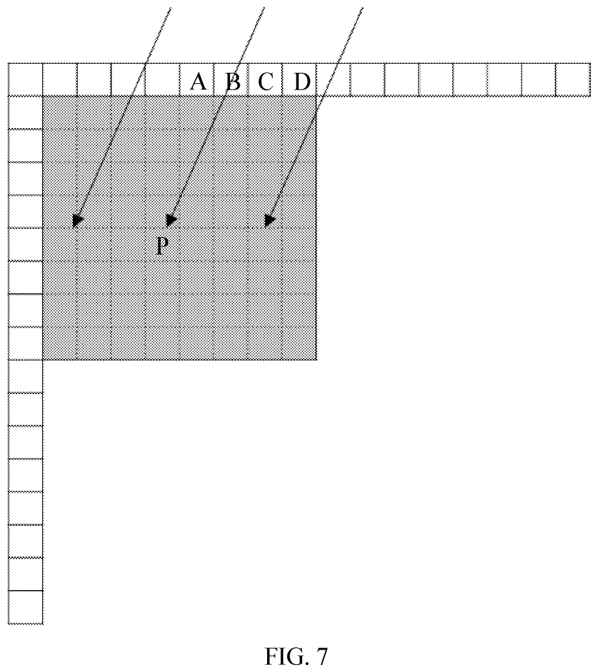

When the angular prediction mode is used, for a pixel in a current prediction block, a reference pixel value at a corresponding position on a reference pixel row or column is used as a predicted value based on a direction corresponding to an angle of the prediction mode. As shown in FIG. 7, for a pixel P in a prediction block, a position of a reference pixel is first determined from a coded pixel row above based on a predicted angle in the figure, and then a value of the reference pixel is used as a predicted value of the pixel P. Not all pixel positions point to reference pixel positions with integer-pixel accuracy. For example, a reference pixel position of the pixel P in FIG. 7 is a sub-pixel position between pixels B and C. Therefore, a predicted pixel value of the position needs to be obtained through interpolation through surrounding pixels. To improve intra prediction efficiency, an on-chip memory is usually configured to store a reference pixel for intra prediction.

As shown in FIG. 8, the inter prediction is to predict, through correlation of a video in a time domain, a pixel of a current picture by using a pixel of an adjacent coded picture, so as to effectively remove redundancy of the video in the time domain, thereby effectively reducing bits for coding residual data. P represents a current frame, Pr represents a reference frame, B represents a current coding block, and Br represents a reference block of B. Coordinates of B′ in the reference frame are the same as coordinates of B in the current frame. The coordinates of Br are (xᵣ, yᵣ), and the coordinates of B′ are (x, y). Displacement between the current coding block and the reference block thereof is referred to as a motion vector (MV), where MV=(xᵣ−x, yᵣ−y).

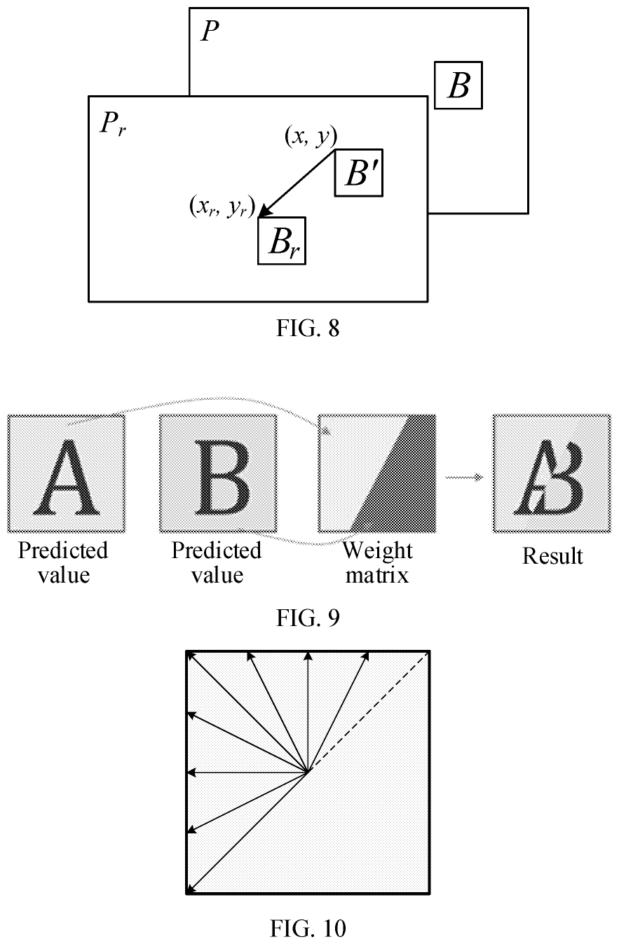

In the second stage of the AVS3, an angular weighted prediction (AWP) mode for inter frame prediction and a spatial angular weighted prediction (SAWP) for intra prediction are used. As shown in FIG. 9, in the AWP mode, a weight value of each pixel position is derived through an intra angular prediction concept. A reference weight value of surrounding positions (an integer-pixel position and a sub-pixel position) of a current block is first set, a weight value corresponding to each pixel position is then obtained through an angular prediction method, and then weighted prediction of two different inter frame predicted values is implemented through the obtained weights. The SAWP uses a similar method to derive a weight and implement weighted prediction of 2 intra predicted values. The AWP mode is described below.

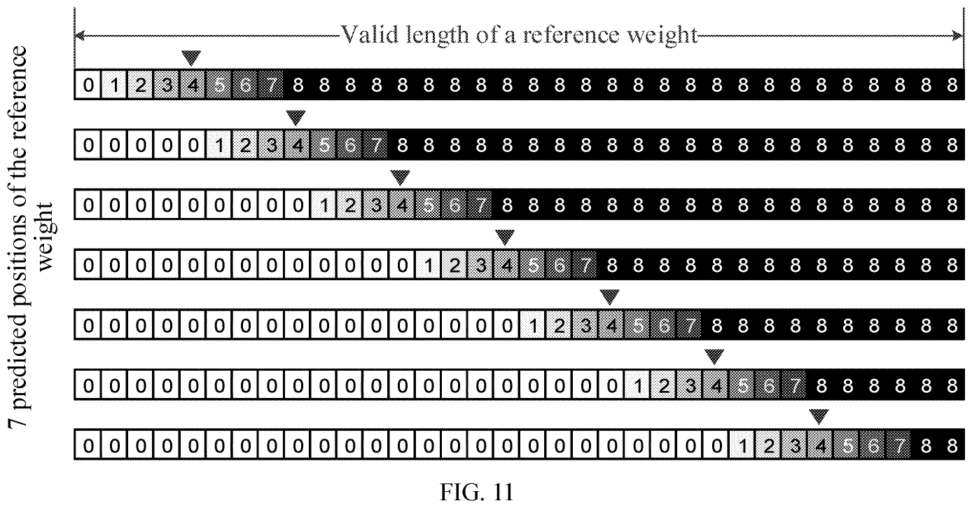

The AWP mode supports a minimum block size of 8 and a maximum block size of 64, with a total of 8 angles supported. As shown in FIG. 10, absolute values of slopes for the 8 angles fall into five categories, which are respectively {horizontal, vertical, 1, 2, ½}. As shown in FIG. 11, each angle supports 7 reference weight configurations. Therefore, for each block, a total of 56 modes exist in the AWP modes. The reference weight configuration is a distribution function of a reference weight value obtained based on a reference weight index value, and a non-strictly monotonic increasing function is assigned by using 8 equally divided point positions of a valid length of a reference weight as reference points, where a valid length of the reference weight is obtained through calculation based on the predicted angle and the current block size.

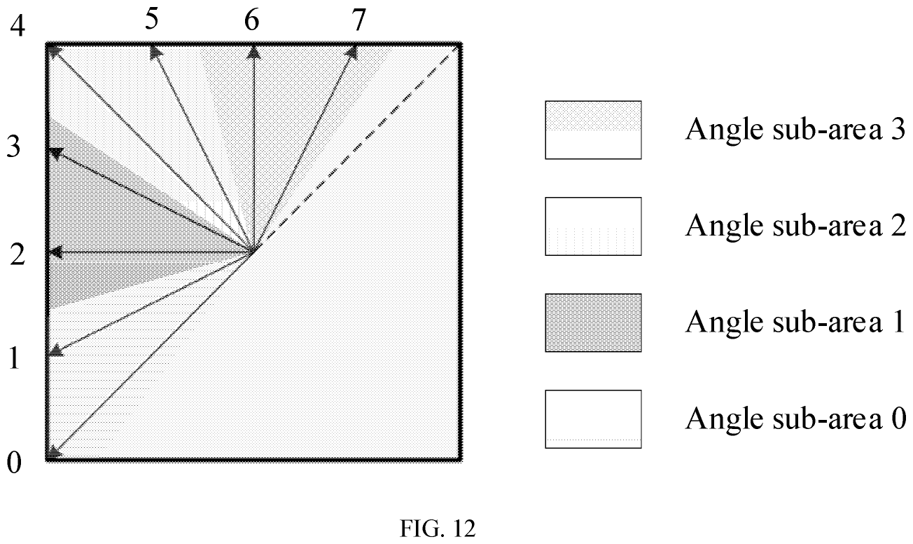

As shown in FIG. 12, an angle supported by the AWP mode is divided into 4 sub-areas, to be specific, an angle sub-area 0, an angle sub-area 1, an angle sub-area 2, and an angle sub-area 3. Based on an area where an angle is located, a formula for deriving a weight pixel by a pixel varies slightly. Specifically, in a code stream, AwpIndex indicates a weight mode used by the current coding block. Relevant parameters of the AWP mode are determined through the following formula based on AwpIndex.

$$stepIndex = ( AwpIndex >> 3 ) - 3$$

$$modAngNum = AwpIndex \%8$$

$$angleAreaIndex = modAngNum >> 1$$

$$angleIndex = \{ \begin{matrix}\begin{matrix}7 , if modAngNum == 2 \\ 8 , if modAngNum == 6\end{matrix} \\ modAngNum \%2\end{matrix}$$

“>>” in the foregoing formula represents a right shift operation. After the foregoing parameters are obtained, a weight matrix of the AWP mode may be derived based on the parameters by using the following method.

First, a valid length of a reference weight vL is calculated. The length vL of the reference weight is indicated through ½ pixel precision. For first 4 angles (namely, when an angle area indication angleAreaIndex is equal to 0 or 1), the reference weight is 1 column to the left of the current block. For the last 4 angles (namely, when the angle area indication angleAreaIndex is equal to 2 or 3), the reference weight is 1 row above the current block. If a width of the current block is Wand a height is H, the valid length vL is calculated in a mode in Table 1.

TABLE 1

| angleAreaIndex | vL |
|---|---|
| 0 | (H + (W >> angleIndex)) << 1 |
| 1 | |
| 2 | (W + (H >> angleindex)) << 1 |
| 3 | |

“<<” in Table 1 indicates a left shift operation. After the valid length vL of the reference weight is obtained through calculation, the reference weight Lw is filled for each sampling point position x (x≤vL) in the following mode. PictureAwpRefneIndex is a picture header index for controlling whether to adjust the reference weight.

$$Lw [ x ] = Clip 3 ( 0 , 8 , ( x - fP ) ≪ shift )$$

$$shift = PictureAwpRefineIndex ? 2 : 0$$

$$o = PictureAwpRefineIndex ? 3 : 1$$

A value of fP is determined based on Table 2 below.

TABLE 2

| angleAreaindex | fp |
|---|---|
| 0 | (vL >> 1) − 3 − o + stepindex * ((vL >> 3) − 1) |
| 1 | (vL >> 1) − 1 − o + stepindex * ((vL >> 3) − 1) − |
| | ((W << 1) >> angleindex) |
| 2 | (vL >> 1) − 1 − o + stepindex * ((vL >> 3) − 1) − |
| | ((H << 1) >> angleindex) |
| 3 | (vL >> 1) − 3 − o + stepindex * ((vŁ >> 3) − 1) |

Next, a brightness weight matrix is filled based on the reference weight. The brightness weight matrix is set to BwLuma (x, y), and BwLuma (x, y)=Lw[tP].

For the SAWP mode or the AWP mode in a B frame, a value of tP is determined based on Table 3 below.

TABLE 3

| angleArcaindex | tP |
|---|---|
| 0 | (y << 1) + ((x << 1) >> angleindex) |
| 1 | (y <<1) − ((x << 1) >> angleindex) |
| 2 | (x <<1) − ((y << 1) >> angleindex) |
| 3 | (x <<1) + ((y << 1) >> angleindex) |

For an AWP mode in a P frame, a value of tP is determined based on Table 4 below.

TABLE 4

| angleAreaIndex | tP |
|---|---|
| 0 | ((y >> 2) << 3) + 4 + ((((x >> 2) << 3) + 4) >> |
| | angleindex) |
| 1 | ((y >> 2) << 3) + 4 − ((((x >> 2) << 3) + 4) >> |
| | angleindex) |
| 2 | ((x >> 2) << 3) + 4 − ((((x >> 2) << 3) + 4) >> |
| | angleIndex) |
| 3 | ((x >> 2) << 3) + 4 + ((((y >> 2) << 3) + 4) >> |
| | angleIndex) |

After the brightness weight matrix is obtained, a chrominance weight matrix BwChroma (x, y) is filled based on the brightness weight matrix.

For an SAWP mode or an AWP mode in a B frame, the chrominance weight matrix is derived based on the following formula.

$$BwChroma [ x ] [ y ] = BwLuma [ x ≪ 1 ] [ y ≪ 1 ]$$

For the AWP mode in the P frame, the chrominance weight matrix is derived based on the following formula.

$$BwChroma [ x ] [ y ] = BwLuma [ ( x ≫ 2 ) ≪ 3 ] [ ( y ≫ 2 ) ≪ 3 ]$$

Finally, a weighted predicted value pred_{x,y} is calculated based on the derived weight matrix and the predicted value.

$${pred}_{x , y} = pr {edA}_{x , y} * {w}_{x , y} + {predB}_{x , y} * ( 1 - {w}_{x , y} )$$

predA_{x,y} and pre dB_{x,y} represent two predicted values of weighted prediction, and w_{x,y} represents a weight value at (x, y). When the weight is 0, the predicted value is predB_{x,y}. When the weight is a maximum value of 1, the predicted value is predA_{x,y}.

During video encoding, a weight is quantized into an integer to reduce a floating-point operation. A range of the weight is set to [0, m], a value of m is set based on precision of the weight. For example, the weight is represented using 3 bits, m=8. A formula of a weighted predicted value pred_{x,y} may be represented as:

$${pred}_{x , y} = ( {predA}_{x , y} * {w}_{x , y} + {predB}_{x , y} * ( 8 - {w}_{x , y} ) + 4 ) ≫ 3$$

When the weight is 0, the predicted value is predB_{x,y}. When the weight is a maximum value of m, the predicted value is predA_{x,y}.

In the AWP and the SAWP, the weight matrix w_{x,y} is derived based on the reference weight. A range of a blending area for reference weights is set to L, and the range thereof may be determined based on a start position and an end position (p₀, p₁), where values of p₀ and p₁ may be the same or different. The reference weight wᵢ may be derived based on the following formula:

$${w}_{i} = \{ \begin{matrix}0 , {x}_{i} ∈ ( - ∞ , {p}_{0} ] \\ f ( d ) , {x}_{i} ∈ ( {p}_{0} , {p}_{1} ) \\ m , {x}_{i} ∈ [ {p}_{1} , + ∞ )\end{matrix}$$

$$or$$

$${w}_{i} = \{ \begin{matrix}0 , {x}_{i} ∈ ( - ∞ , {p}_{0} ) \\ f ( d ) , {x}_{i} ∈ [ {p}_{0} , {p}_{1} ] \\ m , {x}_{i} ∈ ( {p}_{1} , + ∞ )\end{matrix}$$

Based on the foregoing formula, in the blending area, the reference weight is w=f(d).

In a specific implementation, for a function whose value range is greater than a weight value range, a clip function pair may be used for function clipping, namely, w=clip(0, m, f(d)). Alternatively, a weight in a form of an integer may be configured for reducing complexity.

A position of a partition boundary is set to c, and a distance between a sampling point xᵢ on the reference weight and the blending area is set to d. d may be determined based on a distance between the current sampling point and a boundary of the blending area, namely,

$$d = {x}_{i} - c .$$

Alternatively, d may be calculated based on a range of the blending area. Assuming that offset is an offset from a central position to a start position, d may be represented as:

$$d = {x}_{i} - {p}_{0} + offset .$$

d may be represented by using a preset precision integer. For example, d may use, but is not limited to, 8 pixel precision, 4 pixel precision, 2 pixel precision, 1 pixel precision, ½ pixel precision, ¼ pixel precision, 1/64 pixel precision, or the like. In addition, a weight quantized into an integer may be obtained based on the following formula: w_{q}=round(m*f(d)). Alternatively, the following formula is used for calculation:

$${w}_{q} = clip ( 0 , m , round ( m * f ( {d}_{q} ) ) )$$

m is a maximum weight value, round( ) is a rounding function, and f(d) is a function derived by the reference weight.

Because a coding block using the AWP technology needs to code a mode index in a code stream, the mode index may determine a reference weight configuration and a weight prediction angle required for deriving a weight matrix. Currently, 56 AWP modes are supported in the AVS3, and coding these mode indexes in the code stream has relatively large bit overheads. Based on the above, the technical solution in the embodiments of this application proposes that AWP modes may be rearranged, so that an AWP mode with a relatively high probability of being selected has a smaller index value in the mode list, which may effectively reduce coding bit overheads of the AWP mode, thereby improving video encoding and decoding efficiency.

Implementation details of the technical solutions of the embodiments of this application are described below in detail.

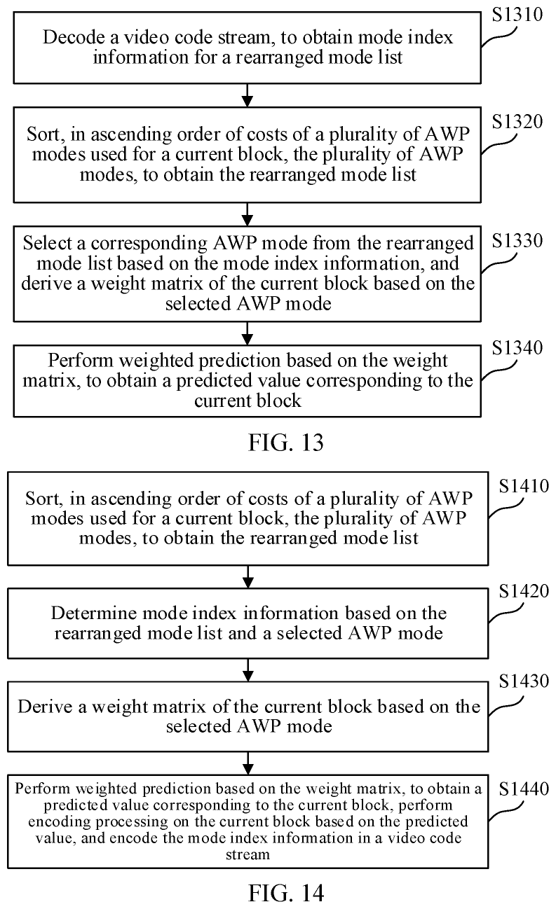

FIG. 13 is a flowchart of a video decoding method according to an embodiment of this application. The video decoding method may be performed by a device having a computing processing function, for example, may be performed by a terminal device or a server. Referring to FIG. 13, the video decoding method includes at least operation S1310 to operation S1340. A detailed description is as follows.

Operation S1310: Decode a video code stream, to obtain mode index information for a rearranged mode list.

In an embodiment of this application, the video code stream is a code stream obtained after a video picture frame sequence is encoded. The video picture frame sequence includes a series of pictures. Each picture may be further partitioned into slices, which may alternatively be referred to as a slice (patch). The slice may be further partitioned into a series of LCUs (or CTUs). The LCU includes several CUs. A video picture frame is encoded in a unit of a block. A coding block or a current block in this embodiment of this application may be a CU, or a block smaller than the CU, such as a smaller block obtained by partitioning the Cu.

In some exemplary embodiments, at least one of the following index information obtained through decoding of the video code stream may be used as the mode index information: index information for indicating the AWP mode, index information for indicating a reference weight configuration, index information for indicating a predicted angle, index information for indicating a reference weight derivation mode, or index information for indicating a weight mode of the AWP mode. The rearranged mode list is a mode list obtained by rearranging one or more pieces of index information included in the mode index information.

In one embodiment, the mode index information may be index information for indicating the AWP mode. In this case, the rearranged mode list is a mode list obtained after the index information of the AWP mode is rearranged.

In one embodiment, the mode index information may be the index information for indicating the reference weight configuration and the index information for indicating the predicted angle. In this case, the rearranged mode list may be a mode list obtained after rearrangement is performed on one or more pieces of index information for indicating the reference weight configuration and index information for indicating the predicted angle.

For example, the index information for indicating the reference weight configuration is denoted as step_idx, and the index information for indicating the predicted angle is denoted as angle_idx. Currently, there are 56 AWP modes in total, namely, 7 weight configurations (step_idx)×8 weight prediction angles (angle_idx). An original arrangement mode of the 56 AWP modes is 8 weight prediction angles corresponding to a 1^{st} weight configuration, 8 weight prediction angles corresponding to a 2^{nd} weight configuration, . . . , and 8 weight prediction angles corresponding to a 7^{th} weight configuration. Then, mode index information awp_mode_idx=step_idx×angle_num+angle_idx, where angle_num is a quantity of predicted angles.

When the mode index information is decoded and step_idx is obtained through decoding, step_idx is not rearranged, and then a weight angle index for the rearranged mode list is obtained through decoding, and is denoted as angle_idx_org. In this case, during a subsequent rearrangement process, corresponding AWP modes step_idx×angle_idx are calculated for the 8 different angle_idx, and then the angle_idx is rearranged through a template matching technology. After the rearrangement is performed, an actually used weight angle index may be found from the rearranged mode list based on the angle_idx_org.

Similarly, the step_idx may also be rearranged in the same mode, and the angle_idx is not rearranged. In addition, another combination form of the mode index information in the foregoing embodiments may also be processed in a similar mode.

In one embodiment, the mode index information may be a combination of the index information for indicating the reference weight derivation mode and the index information for indicating the AWP mode. In this case, the rearranged mode list may be a mode list obtained after rearrangement is performed on one or more pieces of index information for indicating the reference weight derivation mode and the index information for indicating the reference weight derivation mode.

For example, the index information for indicating the reference weight derivation mode is denoted as blend_idx, and the index information for indicating the AWP mode is denoted as awp_mode_idx. A method similar to the foregoing may be used. When blend_idx is obtained through decoding, the rearrangement is not performed, and the AWP mode is rearranged for awp_mode_idx.

In some exemplary embodiments, another index information may be derived based on the index information for indicating the AWP mode. For example, the index information for indicating the AWP mode is denoted as awp_mode_idx, the index information for indicating the reference weight configuration is denoted as step_idx, and the index information for indicating the predicted angle is denoted as angle_idx. Another index information may be derived based on the awp_mode_idx in the following mode:

$$angle\_idx = awp\_mode \_idx \% awp\_angle \_num ; and$$

$$step\_idx = awp\_mode \_idx / awp\_angle \_num , where$$

$$awp\_angle \_num = 8 .$$

In one embodiment, the mode index information may be the index information for indicating the reference weight derivation mode, the index information for indicating the reference weight configuration, and the index information for indicating the predicted angle. In this case, the rearranged mode list may be a mode list obtained after rearrangement is performed on one or more pieces of index information for indicating the reference weight derivation mode, index information for indicating the reference weight configuration, and index information for indicating the predicted angle.

In one embodiment, the mode index information may be index information for indicating a weight mode of the AWP mode. In this case, the rearranged mode list may be a mode list obtained after rearrangement is performed on the index information for indicating the weight mode of the AWP mode. The index information for indicating the AWP mode and the index information for indicating the reference weight derivation mode may be derived from the index information for indicating the weight mode of the AWP mode. However, the index information for indicating the reference weight configuration and the index information for indicating the predicted angle may further be derived from the index information for indicating the AWP mode. For example, the index information for indicating the weight mode of the AWP mode is denoted as cu_awp_blend_mode_idx, the index information for indicating the AWP mode is denoted as awp_mode_idx, the index information for indicating the reference weight derivation mode is denoted as blend_idx, the index information for indicating the reference weight configuration is denoted as step_idx, and the index information for indicating the predicted angle is denoted as angle_idx. Another index information may be derived in the following mode:

$$awp\_mode \_idx = cu\_awp \_blend \_mode \_idx \% awp\_mode \_num ;$$

$$blend\_idx = cu\_awp \_blend \_mode \_idx / awp\_mode \_num ;$$

$$angle\_idx = awp\_mode \_idx \% awp\_angle \_num ; and$$

$$step\_idx = awp\_mode \_idx / awp\_angle \_num , where$$

$$awp\_angle \_num = 8 , and awp\_mode \_num = 56 .$$

Operation S1320: Sort, in ascending order of costs of a plurality of AWP modes used for a current block, the plurality of AWP modes, to obtain the rearranged mode list.

In one embodiment, the AWP mode in this embodiment of this application may be the AWP mode or the SAWP mode.

In some exemplary embodiments, in operation S1320, an index flag bit included in the video code stream is decoded; and the plurality of AWP modes are sorted in ascending order of the costs of the plurality of AWP modes if it is determined, based on the index flag bit, that use of a rearrangement-based AWP mode is allowed for the current block, to obtain the rearranged mode list. In other words, before the AWP modes are sorted, the index flag bit included in the video code stream may further be decoded. If it is determined, based on the index flag bit, that the use of the rearrangement-based AWP mode is allowed for the current block, a process of sorting the plurality of AWP modes is performed.

In some exemplary embodiments, it may be determined whether the use of the rearrangement-based AWP mode is allowed for a current sequence based on a sequence header flag bit included in sequence header information. For example, if a value of the sequence header flag bit is 1, the use of the rearrangement-based AWP mode is allowed for the current sequence. If the value of the sequence header flag bit is 0, the use of the rearrangement-based AWP mode is not allowed for the current sequence.

In some exemplary embodiments, it may be determined whether the use of the rearrangement-based AWP mode is allowed for a current picture based on a picture header flag bit included in picture header information. For example, if a value of the picture header flag bit is 1, the use of the rearrangement-based AWP mode is allowed for the current picture. If the value of the picture header flag bit is 0, the use of the rearrangement-based AWP mode is not allowed for the current picture.

In some exemplary embodiments, it may be determined whether the use of the rearrangement-based AWP mode is allowed for a current slice based on a slice header flag bit included in slice header information. For example, if a value of the slice header flag bit is 1, the use of the rearrangement-based AWP mode is allowed for the current slice. If the value of the slice header flag bit is 0, the use of the rearrangement-based AWP mode is not allowed for the current slice.

In some exemplary embodiments, it may further be determined whether use of the rearrangement-based AWP mode is allowed based on two or more of sequence header flag bits included in the sequence header information, picture header flag bits included in picture header information, and slice header flag bits included in the slice header information.

For example, whether the use of the rearrangement-based AWP mode is allowed for a coding block using a weighted prediction mode based on the sequence header flag bit and the picture header flag bit. Specifically, if the value of the sequence header flag bit and the value of the picture header flag bit are both 1, the use of the rearrangement-based AWP mode is allowed for the current picture. If the value of the sequence header flag bit is 1 and the value of the picture header flag bit is 0, the use of the rearrangement-based AWP mode is not allowed for the current picture. If the value of the sequence header flag bit is 0, no matter what value of the picture header flag bit is (actually, the value of the picture header flag bit does not need to be decoded), it may be considered that the use of the rearrangement-based AWP mode is not allowed for the current sequence.

In some exemplary embodiments, the index flag bit configured for determining whether the use of the rearrangement-based AWP mode is allowed for the current block may include one or more flag bits, different values of the one or more flag bits being configured for indicating whether use of the AWP mode is allowed for a corresponding coding block, and whether the use of the rearrangement-based AWP mode is allowed when the use of the AWP mode is allowed.

For example, the index flag bit includes one flag bit. When the value of the flag bit is 0, the use of the AWP mode is not allowed for a corresponding coding block. When the value of the flag bit is 1, the use of the AWP mode is allowed for the corresponding coding block, but the use of the rearrangement-based AWP mode is not allowed. When the value of the flag bit is 2, the use of both the AWP mode and the rearrangement-based AWP mode is allowed for the corresponding coding block.

For another example, the index flag bit includes two flag bits (denoted as a first flag bit and a second flag bit). If a value of the first flag bit is 0, it may be determined that the use of the AWP mode is not allowed for the corresponding coding block without decoding the second flag bit. If the value of first flag bit is 1 and the value of the second flag bit is 0, it is determined that the use of the AWP mode is allowed for the corresponding coding block, but the use of the rearrangement-based AWP mode is not allowed. If the value of the first flag bit is 1 and the value of the second flag bit is 1, it is determined that the use of both the AWP mode and the rearrangement-based AWP mode is allowed for the corresponding coding block.

In some exemplary embodiments, when a picture frame type is a specified type (for example, an I-frame picture or a B-frame picture), the foregoing index flag bit may be further decoded from the video code stream. Alternatively, when the picture frame type is a non-specified type (for example, a non-I-frame picture), the foregoing index flag bit may be decoded from the video code stream.

In an embodiment of this application, if it is determined that the use of the AWP mode is allowed for the current block, a syntax element for deriving a weight matrix and a syntax element for determining a plurality of predicted values may be decoded from the video code stream.

In some exemplary embodiments, the syntax element for deriving the weight matrix includes at least one of the following syntax elements: index information for indicating the AWP mode, index information for indicating a reference weight configuration, index information for indicating a predicted angle, index information for indicating a reference weight derivation mode, index information for indicating a weight mode of the AWP mode, or index information for indicating a size of a reference weight blending area.

In one embodiment, the syntax element for deriving the weight matrix may be the index information for indicating the AWP mode.

In one embodiment, the syntax element for deriving the weight matrix may be the index information for indicating the reference weight derivation mode and the index information for indicating the AWP mode.

In one embodiment, the syntax element configured for deriving the weight matrix may be the index information for indicating the reference weight derivation mode, the index information for indicating the reference weight configuration, and the index information for indicating the predicted angle.

In one embodiment, the syntax element configured for deriving the weight matrix may be the index information for indicating the weight mode of the AWP mode.

In one embodiment, the syntax element configured for deriving the weight matrix may be the index information for indicating the reference weight configuration and the index information for indicating the predicted angle.

In some exemplary embodiments, the syntax element for determining the plurality of predicted values includes at least one of the following syntax elements: index information configured for determining a predicted motion vector of a reference block, a syntax element for determining to correct the motor vector, and a syntax element for determining an intra prediction mode (the syntax element for determining the intra prediction mode needs to be used in the SAWP mode).

In one embodiment, the syntax element for determining to correct the motor vector includes: index information for indicating whether the motion vector needs to be corrected, index information for indicating a step size of motion vector correction, and index information for indicating a motion vector correction direction. The index information for indicating the step size of motion vector correction and the index information for indicating the motion vector correction direction are mainly configured for deriving a motion vector difference (MVD). In this way, motion vector (MV)=motion vector predictor (MVP)+MVD.

In one embodiment, the index information for indicating whether the motion vector needs to be corrected and the index information for indicating a motion vector difference are provided. In other words, in this embodiment, the MVD may be directly obtained by decoding the code stream.

In some exemplary embodiments, all or part of the syntax element configured for deriving the weight matrix and the syntax elements configured for determining the plurality of predicted values may be decoded in a specified mode. Specific descriptions are provided below.

In one embodiment, part or all of binary digits of the syntax element may be decoded through a variable-length code. For example, decoding processing may be performed through a k-order exponential Golomb code, a truncated unary code, a truncated binary code, or the like.

In one embodiment, part or all of the binary digits of the syntax element may be decoded through a fixed-length code.

In one embodiment, different parts of the binary digits of the syntax element may be respectively decoded through different variable-length codes. For example, a prefix part is decoded through the truncated unary code, and a suffix part is decoded through the truncated binary code.

In one embodiment, part of the syntax element in which a binary digit is less than a set threshold may be decoded through a decoding method corresponding to a context-based binary encoding method, and the remaining part may be decoded through a decoding method corresponding to a bypass coding mode.

In one embodiment, part or all of the binary digits of the syntax element are decoded through a combination of the variable-length code and the fixed-length code. For example, the prefix part is decoded through the variable-length code, and the suffix part is decoded through the fixed-length code. For another example, if a quantity of the decoded AWP modes (less than or equal to a total quantity of AWP modes) is divided into a plurality of groups based on a set grouping manner, index information in the mode index information for indicating a group number may be decoded through the variable-length code, and index information in the mode index information for indicating an element within a group may be decoded through the fixed-length code.

In an embodiment of this application, before the AWP modes are sorted, costs of using various AWP modes by the current block need to be calculated. Specifically, various Decoded AWP modes need to be traversed, then a current template corresponding to the current block is obtained, and a prediction template corresponding to a reference block of the current block is obtained. Afterward, a template weight corresponding to the prediction template is determined based on a weight derived from each AWP mode, a weighted prediction template is calculated based on the template weight and the prediction template, and finally, a cost of each AWP mode is calculated based on the weighted prediction template and the current template.

In some exemplary embodiments, the current template corresponding to the current block includes at least one of the following sampling points: a sampling point located in a set row above a current block; a sampling point located in a set column to a left of the current block; a sampling point obtained through sampling of a sampling point adjacent to the current block based on a set interval; or the sampling points located in the set row above the current block and in the set column to the left of the current block.

In some exemplary embodiments, the prediction template corresponding to the reference block of the current block includes at least one of the following sampling points: a sampling point located in a set row above the reference block; a sampling point located in a set column to a left of the reference block; a sampling point in the set row within the reference block; a sampling point within the reference block in the set column; a sampling point obtained through sampling of a sampling point adjacent to the reference block based on the set interval; a sampling point obtained through sampling of the sampling point within the reference block based on the set interval; the sampling points located in the set row above the reference block and in the set column to the left of the reference block; or the sampling points in the set row above the reference block and in the set column to the left of the reference block.

The prediction template may correspond to the current template. In other words, a position of the prediction template relative to the reference block is the same as a position of the current template relative to the current block. Alternatively, the prediction template may not correspond to the current template.

In some exemplary embodiments, after the current template is selected, correction processing may be performed on a sampling point in the current template. However, after the prediction template is selected, correction processing may also be performed on the sampling point in the prediction template. In one embodiment, performing correction processing on a sampling point includes one or more of filtering processing, linear mapping processing, and non-linear mapping processing.

In some exemplary embodiments, for an AWP mode in which a derived weight is greater than the weight threshold, the template weight is set to 1, and for an AWP mode in which the derived weight is less than the weight threshold, the template weight is set to 0. Alternatively, if the position of the sampling point corresponding to the prediction template after projection based on the weight prediction angle is on a left side of a central position of a blending area, the template weight is set to 0. Otherwise (namely, the position of the sampling point corresponding to the prediction template after the projection based on the weight prediction angle is on a right side of the central position of the blending area or overlaps the central position), the template weight is set to 1. In other words, after the weight corresponding to the prediction template is derived based on each AWP mode, the template weight may further be determined through the derived weight.

In some exemplary embodiments, when the costs of the AWP mode are calculated, a sum of absolute difference (SAD for short), a sum of squared difference (SSD for short), or a mean-reduced SAD (MR-SAD for short) between the weighted prediction template and the current template may be calculated as the cost of the AWP mode.

In some exemplary embodiments, when the costs are calculated, only a sampling point with the difference less than the set threshold may be calculated. In other words, an SAD, or an SSD, or an MR-SAD between target sampling points where a difference between the sampling points in the weighted prediction template and the current template is less than a set threshold is calculated.

In some exemplary embodiments, when the AWP modes are sorted, the sorting may be stopped if a quantity of AWP modes that are sorted in ascending order of the costs reaches a set quantity, the set quantity being less than or equal to a total quantity of the AWP modes. In one embodiment, the set quantity may be a quantity of the decoded AWP modes.

Operation S1330: Select a corresponding AWP mode from the rearranged mode list based on the mode index information, and derive a weight matrix of the current block based on the selected AWP mode.

In some exemplary embodiments, a process of deriving the weight matrix of the current block based on the selected AWP mode may be: deriving the reference weight of the current block based on the selected AWP mode, and then calculating the weight matrix corresponding to the current block based on the reference weight and the weight prediction angle used by the current block. For a specific calculation process, reference may be made to the description in the foregoing embodiments. Details are not described herein again.

Operation S1340: Perform weighted prediction based on the weight matrix, to obtain a predicted value corresponding to the current block.

For a process of performing weighted prediction based on the weight matrix to obtain the predicted value corresponding to the current block, reference may be made to the description in the foregoing embodiments. Details are not described herein again.

FIG. 14 is a flowchart of a video encoding method according to an embodiment of this application. The video encoding method may be performed by a device having a computing processing function, for example, may be performed by a terminal device or a server. Referring to FIG. 14, the video encoding method includes at least operation S1410 to operation S1440. A detailed description is as follows.

Operation S1410: Sort, in ascending order of costs of a plurality of AWP modes used for a current block, the plurality of AWP modes, to obtain the rearranged mode list.

Operation S1420: Determine mode index information based on the rearranged mode list and a selected AWP mode.

Operation S1430: Derive a weight matrix of the current block based on the selected AWP mode.

Operation S1440: Perform weighted prediction based on the weight matrix, to obtain a predicted value corresponding to the current block, perform encoding processing on the current block based on the predicted value, and encode the mode index information in a video code stream.

A specific processing process on the coder end is similar to that on the decoder end, and details are not described herein again.

Based on the above, in the technical solution in the embodiments of this application, the AWP mode having a relatively high probability of being selected (namely, a relatively low cost) has a smaller index value in the rearranged mode list, so as to effectively reduce coding bit overheads of the AWP mode index information, thereby helping improve encoding and decoding performance.

Implementation details of the technical solution in the embodiments of this application are described below in detail again from a perspective of the decoder end.

The technical solution in the embodiments of this application mainly includes the following four processes. Process 1: Decode a code stream, and determine whether the AWP mode is used in the coding block. Process 2: Decode the code stream if the AWP mode is used, and determine the syntax element related to the AWP mode, including a syntax element for determining a weight matrix and a syntax element for determining a predicted value of each part. Process 3: Derive a rearranged mode list and a corresponding prediction mode if the rearrangement-based AWP mode is used. Process 4: Derive a weight matrix based on the derived prediction mode, to perform weighted prediction.

The technical solution in the embodiments of this application is not only applicable to the AWP mode, but also applicable to the SWAP mode. Detailed descriptions of the foregoing four processes are provided below by using the AWP mode as an example.

Process 1: Decode the code stream, and determine whether the AWP mode is used in the coding block.

The following methods may be used alone or in combination.

In an embodiment of this application, a sequence header syntax element is included in the code stream to indicate whether the AWP mode is used in the current sequence, and whether the rearrangement-based AWP mode is used.

The rearrangement-based AWP mode means that the decoder end needs to perform rearrangement processing on the AWP mode. Therefore, the mode may also be referred to as the AWP mode on the decoder end (Decode AWP, DAWP for short). A description is provided below by using an example in which the rearrangement-based AWP mode is represented as the DAWP. Certainly, to be consistent with the decoder end, the coder end actually also includes a rearrangement operation.

In some exemplary embodiments, the code stream may include 2 flags, for example, a sequence header AWP mode flag seq_awp_flag and a sequence header rearrangement-based AWP mode flag seq_dawp_flag, which are configured for indicating whether the AWP mode is used in the current sequence. A specific indication mode may be shown in Table 5 (“x” in Table 5 indicates that decoding is not needed).

TABLE 5

| seq_awp_flag | seq_dawp_flag | Semantics |
|---|---|---|
| 0 | x | Use of the AWP mode is not allowed |
| 1 | 0 | Use of the AWP mode is allowed, but |
| | | use of the DAWP mode is not allowed |
| 1 | 1 | Use of the AWP mode is allowed, and |
| | | use of the DAWP mode is allowed |

seq_awp_flag may be a binary variable, where a value of 1 indicates that the use of the AWP mode is allowed for the current sequence, and a value of 0 indicates that the use of the AWP mode is not allowed. seq_dawp_flag may be a binary variable, where a value of 1 indicates that the use of the DAWP mode is allowed, and a value of 0 indicates that the use of the DAWP mode is not allowed. Still referring to Table 5, when seq_awp_flag is 0, it may be determined that the use of the AWP mode is not allowed for the current sequence without decoding seq_dawp_flag. When seq_awp_flag is 1 and seq_dawp_flag is 0, it may be determined that the use of the AWP mode is allowed for the current sequence, and the use for the DAWP mode is not allowed. When both seq_awp_flag and seq_dawp_flag are 1, it may be determined that the use of the AWP mode is allowed for the current sequence, and the use for the DAWP mode is allowed.

In an example, a decoding process of seq_awp_flag and seq_dawp_flag is shown in Table 6.

TABLE 6

| | |
|---|---|
| seq_awp_flag | u(1) |
| if(SeqAwpFlag) { | |
| seq_dawp_flag | u(1) |
| } | |

Referring to Table 6, seq_awp_flag is first decoded. If seq_awp_flag indicates that the use of the AWP mode is allowed for the current sequence, seq_dawp_flag is decoded. If seq_awp_flag indicates that the use of the AWP mode is not allowed for the current sequence, seq_dawp_flag does not need to be decoded. Description identifiers of seq_awp_flag and seq_dawp_flag may both be u(1), namely, a 1-bit unsigned integer. The value of SeqAwpFlag is equal to the value of seq_awp_flag. If seq_awp_flag does not exist in the code stream, the value of SeqAwpFlag is 0.

In some exemplary embodiments, only one flag, namely, a sequence header AWP mode flag seq_awp_flag, may exist in the code stream, to indicate whether the AWP mode is used in the current sequence. A specific indication mode may be shown in Table 7:

TABLE 7

| seq_awp_flag | Semantics |
|---|---|
| 0 | Use of the AWP mode is not allowed |
| 1 | Use of the AWP mode is allowed, but |
| | use of the DAWP mode is no tallowed |
| 2 | Use of the AWP mode is allowed, and |
| | use of the DAWP mode is allowed |

seq_awp_flag represents a mode type of the AWP mode, where a value of “0” represents that the use of the AWP is not allowed, and a value greater than “0” represents that the AWP may be used and represents whether the use of the DAWP is allowed. A description identifier of seq_awp_flag may be u(2), namely, a 2-bit unsigned integer, or may be ue(v), namely, an unsigned integer syntax element.

Referring to Table 7, when seq_awp_flag is 0, the use of the AWP mode is not allowed for the current sequence. When seq_awp_flag is 1, the use of the AWP mode is allowed for the current sequence, but the use of the DAWP mode is not allowed. When seq_awp_flag is 2, the use of the AWP mode is allowed for the current sequence, and the use of the DAWP mode is allowed.

In an embodiment of this application, a picture header syntax element is included in the code stream to indicate whether the AWP mode is used in the current picture, and whether the rearrangement-based AWP mode is used.

In some exemplary embodiments, the code stream may include 2 flags, for example, a picture header AWP mode flag pic_awp_flag and a picture header rearrangement-based AWP mode flag pic_dawp_flag, which are configured for indicating whether the AWP mode is used in the current picture. A specific indication mode may be shown in Table 8 (“x” in Table 8 indicates that decoding is not needed).

TABLE 8

| pic_awp_flag | pic_dawp_flag | Semantics |
|---|---|---|
| 0 | x | Use of the AWP mode is not allowed |
| 1 | 0 | Use of the AWP mode is allowed, but |
| | | use of the DAWP mode is not allowed |
| 1 | 1 | Use of the AWP mode is allowed, and |
| | | use of the DAWP mode is allowed |

pic_awp_flag may be a binary variable, where a value of 1 indicates that the use of the AWP mode is allowed for the current picture, and a value of 0 indicates that the use of the AWP mode is not allowed. pic_dawp_flag may be a binary variable, where a value of 1 indicates that the use of the DAWP mode is allowed, and a value of 0 indicates that the use of the DAWP mode is not allowed. Referring to Table 8, when pic_awp_flag is 0, it may be determined that the use of the AWP mode is not allowed for the current picture without decoding pic_dawp_flag. When pic_awp_flag is 1 and pic_dawp_flag is 0, it may be determined that the use of the AWP mode is allowed for the current picture, and the use of the DAWP mode is not allowed. When both pic_awp_flag and pic_dawp_flag are 1, it may be determined that the use of the AWP mode is allowed for the current picture, and the use of the DAWP mode is allowed.

In an example, a decoding process of pic_awp_flag and pic_dawp_flag is shown in Table 9.

TABLE 9

| | |
|---|---|
| pic_awp_flag | u(1) |
| if(PicAwpFlag) { | |
| pic_dawp_flag | u(1) |
| } | |

Referring to Table 9, pic_awp_flag is first decoded. If pic_awp_flag indicates that the use of the AWP mode is allowed for the current picture, pic_dawp_flag is then decoded. If pic_awp_flag indicates that the use of the AWP mode is not allowed for the current picture, pic_dawp_flag does not need to be decoded. Description identifiers of pic_awp_flag and pic_dawp_flag may both be u(1), namely, a 1-bit unsigned integer. The value of PicAwpFlag is equal to the value of pic_awp_flag. If pic_awp_flag does not exist in a code stream, the value of PicAwpFlag is 0.

In some exemplary embodiments, only one flag, namely, a picture header AWP mode pic_awp_flag, may exist in the code stream, to indicate whether the AWP mode is used in the current picture. A specific indication mode may be shown in Table 10:

TABLE 10

| pic_awp_flag | Semantics |
|---|---|
| 0 | Use of the AWP mode is not allowed |
| 1 | Use of the AWP mode is allowed, but |
| | use of the DAWP mode is not allowed |
| 2 | Use of the AWP mode is allowed, and |
| | use of the DAWP mode is allowed |

pic_awp_flag represents a mode type of the AWP mode, where a value of “0” represents that the use of the AWP is not allowed, and a value greater than “0” represents that the AWP may be used and represents whether the use of the DAWP is allowed. A description identifier of pic_awp_flag may be u(2), namely, a 2-bit unsigned integer, or may be ue(v), namely, an unsigned integer syntax element.

Referring to Table 10, when pic_awp_flag is 0, the use of the AWP mode is not allowed for the current picture. When pic_awp_flag is 1, the use of the AWP mode is allowed for the current picture, and the use of the DAWP mode is not allowed. When pic_awp_flag is 2, the use of the AWP mode is allowed for the current picture, and the use of the DAWP mode is allowed.

In some exemplary embodiments, only one picture header syntax element pic_dawp_flag may exist in the code stream, to indicate whether the DAWP mode is used in the current picture. A specific indication mode may be shown in Table 11 for indication with reference to seq_awp_flag (“x” in Table 11 indicates that decoding is not needed).

| seq_awp_flag | pic_dawp_flag | Semantics |
|---|---|---|
| 0 | x | Use of the AWP mode is not allowed |
| 1 | 0 | Use of the AWP mode is allowed, but |
| | | use of the DAWP mode is not allowed |
| 1 | 1 | Use of the AWP mode is allowed, and |
| | | use of the DAWP mode is allowed |

seq_awp_flag may be a binary variable, where a value of 1 indicates that the use of the AWP mode is allowed, and a value of 0 indicates that the use of the AWP mode is not allowed. pic_dawp_flag may be a binary variable, where a value of 1 indicates that the use of the DAWP mode is allowed, and a value of 0 indicates that the use of the DAWP mode is not allowed.

Referring to Table 11, when seq_awp_flag is 0, it may be determined that the use of the AWP mode is not allowed for the current picture (use of the AWP mode is not allowed for an entire sequence) without decoding pic_dawp_flag. When seq_awp_flag is 1 and pic_dawp_flag is 0, it may be determined that the use of the AWP mode is allowed for the current picture, and the use of the DAWP mode is not allowed. When both seq_awp_flag and pic_dawp_flag are 1, it may be determined that the use of the AWP mode is allowed for the current picture, and the use of the DAWP mode is allowed.

In an example, a decoding process of seq_awp_flag and pic_dawp_flag is shown in Table 12.

TABLE 12

| | |
|---|---|
| seq_awp_flag | u(1) |
| if(SeqAwpFlag) { | |
| pic_dawp_flag | u(1) |
| } | |

Referring to Table 12, seq_awp_flag is first decoded. If seq_awp_flag indicates that the use of the AWP mode is allowed for the current sequence, seq_awp_flag is then decoded. Description identifiers of seq_awp_flag and pic_dawp_flag may both be u(1), namely, a 1-bit unsigned integer. The value of SeqAwpFlag is equal to the value of seq_awp_flag. If seq_awp_flag does not exist in the code stream, the value of SeqAwpFlag is 0.

In some exemplary embodiments, only one picture header syntax element pic_dawp_flag may exist in the code stream, to indicate whether the DAWP mode is used in the current picture. A specific indication mode may be shown in Table 13 for indication with reference to seq_dawp_flag (“x” in Table 13 indicates that decoding is not needed).

TABLE 13

| seq_dawp_flag | pic_dawp_flag | Semantics |
|---|---|---|
| 0 | x | Use of the AWP mode |
| | | is not allowed |
| 1 | 0 | Use of the DAWP mode |
| | | is not allowed |
| 1 | 1 | Use of the DAWP mode |
| | | is allowed |

seq_dawp_flag may be a binary variable, where a value of 1 indicates that the use of the DAWP mode is allowed, and a value of 0 indicates that the use of the DAWP mode is not allowed. pic_dawp_flag may be a binary variable, where a value of 1 indicates that the use of the DAWP mode is allowed, and a value of 0 indicates that the use of the DAWP mode is not allowed.

Referring to Table 13, when seq_dawp_flag is 0, it may be determined that the use of the DAWP mode is not allowed for the current picture (the use of the DAWP mode is not allowed for an entire sequence) without decoding pic_dawp_flag. When seq_dawp_flag is 1 and pic_dawp_flag is 0, it may be determined that the use of the DAWP mode is not allowed for the current picture. When both seq_dawp_flag and pic_dawp_flag are 1, it may be determined that the use of the DAWP mode is allowed for the current picture.

In an example, a decoding process of seq_dawp_flag and pic_dawp_flag is shown in Table 14.

TABLE 14

| | |
|---|---|
| seq_dawp_flag | u(1) |
| if(SeqDawpFlag) { | |
| pic_dawp_flag | u(1) |
| } | |

Referring to Table 14, seq_dawp_flag is first decoded. If seq_dawp_flag indicates that the use of the DAWP mode is allowed for the current sequence, pic_dawp_flag is then decoded. Description identifiers of seq_dawp_flag and pic_dawp_flag may both be u(1), namely, a 1-bit unsigned integer. The value of SeqDawpFlag is equal to the value of seq_dawp_flag. If seq_dawp_flag does not exist in the code stream, the value of SeqDawpFlag is 0.

In an embodiment of this application, a slice header syntax element is included in the code stream to indicate whether the AWP mode is used in a current slice.

In some exemplary embodiments, the code stream may include 2 flags, for example, a slice header AWP mode flag slice_awp_flag and a slice header rearrangement-based AWP mode flag slice_dawp_flag, to indicate whether the AWP mode is used in the current slice. A specific indication mode may be shown in Table 15 (“x” in Table 15 indicates that decoding is not needed).

TABLE 15

| slice_awp_flag | slice_dawp_flag | Semantics |
|---|---|---|
| 0 | x | Use of the AWP mode is not allowed |
| 1 | 0 | Use of the AWP mode is allowed, but |
| | | use of the DAWP mode is not allowed |
| 1 | 1 | Use of the AWP mode is allowed, and |
| | | use of the DAWP mode is allowed |

slice_awp_flag may be a binary variable, where a value of 1 indicates that the use of the AWP mode is allowed for the current slice, and a value of 0 indicates that the use of the AWP mode is not allowed. slice_dawp_flag may be a binary variable, where a value of 1 indicates that the use of the DAWP mode is allowed, and a value of 0 indicates that the use of the DAWP mode is not allowed. Referring to Table 15, when slice_awp_flag is 0, it may be determined that the use of the AWP mode is not allowed for the current slice without decoding slice_dawp_flag. When slice_awp_flag is 1 and slice_dawp_flag is 0, it may be determined that the use of the AWP mode is allowed for the current slice, and the use of the DAWP mode is not allowed. When both slice_awp_flag and slice_dawp_flag are 1, it may be determined that the use of the AWP mode is allowed for the current slice, and the use of the DAWP mode is allowed.

In an example, a decoding process of slice_awp_flag and slice_dawp_flag is shown in Table 16.

TABLE 16

| | |
|---|---|
| slice_awp_flag | u(1) |
| if(SliceAwpFlag) { | |
| slice_dawp_flag | u(1) |
| } | |

Referring to Table 16, slice_awp_flag is first decoded. If slice_awp_flag indicates that the use of the AWP mode is allowed for the current slice, slice_dawp_flag is then decoded. If slice_awp_flag indicates that the use of the AWP mode is not allowed for the current slice, slice_dawp_flag does not need to be decoded. Description identifiers of slice_awp_flag and slice_dawp_flag may both be u(1), namely, a 1-bit unsigned integer. The value of SliceAwpFlag is equal to the value of slice_awp_flag. If slice_awp_flag does not exist in the code stream, the value of SliceAwpFlag is 0.

In some exemplary embodiments, only one flag, namely, a slice header AWP mode flag slice_awp_flag, may exist in the code stream, to indicate whether the AWP mode is used in the current slice. A specific indication mode may be shown in Table 17:

TABLE 17

| slice_awp_flag | Semantics |
|---|---|
| 0 | Use of the AWP mode is not allowed |
| 1 | Use of the AWP mode is allowed, but |
| | use of the DAWP mode is not allowed |
| 2 | Use of the AWP mode is allowed, and |
| | use of the DAWP mode is allowed |

slice_awp_flag represents a mode type of the AWP mode, where a value of “0” represents that the use of the AWP is not allowed, and a value greater than “0” represents that the AWP may be used and represents whether the use of the DAWP is allowed. A description identifier of slice_awp_flag may be u(2), namely, a 2-bit unsigned integer, or may be ue(v), namely, an unsigned integer syntax element.

Referring to Table 17, when slice_awp_flag is 0, the use of the AWP mode is not allowed for the current slice. When slice_awp_flag is 1, the use of the AWP mode is allowed for the current slice, and the use of the DAWP mode is not allowed. When slice_awp_flag is 2, the use of the AWP mode is allowed for the current slice, and the use of the DAWP mode is allowed.

In some exemplary embodiments, only one slice header syntax element slice_dawp_flag may exist in the code stream, to indicate whether the DAWP mode is used in the current slice. A specific indication mode may be shown in Table 18 for indication with reference to pic_awp_flag (“x” in Table 18 indicates that decoding is not needed).

TABLE 18

| pic_awp_flag | slice_dawp_flag | Semantics |
|---|---|---|
| 0 | x | Use of the AWP mode is not allowed |
| 1 | 0 | Use of the AWP mode is allowed, but |
| | | use of the DAWP mode is not allowed |
| 1 | 1 | Use of the AWP mode is allowed, and |
| | | use of the DAWP mode is allowed |

pic_awp_flag may be a binary variable, where a value of 1 indicates that the use of the AWP mode is allowed, and a value of 0 indicates that the use of the AWP mode is not allowed. slice_dawp_flag may be a binary variable, where a value of 1 indicates that the use of the DAWP mode is allowed, and a value of 0 indicates that the use of the DAWP mode is not allowed.

Referring to Table 18, when pic_awp_flag is 0, it may be determined that the use of the AWP mode is not allowed for the current slice (the use of the AWP mode is not allowed for an entire picture) without decoding slice_dawp_flag. When pic_awp_flag is 1 and slice_dawp_flag is 0, it may be determined that the use of the AWP mode is allowed for the current slice, and the use of the DAWP mode is not allowed. When both pic_awp_flag and slice_dawp_flag are 1, it may be determined that the use of the AWP mode is allowed for the current slice, and the use of the DAWP mode is allowed.

In an example, a decoding process of pic_awp_flag and slice_dawp_flaT is shown in Table 19.

TABLE 19

| | |
|---|---|
| pic_awp_flag | u(1) |
| if(PicAwpFlag) { | |
| slice_dawp_flag | u(1) |
| } | |

Referring to Table 19, pic_awp_flag is first decoded. If pic_awp_flag indicates that the use of the AWP mode is allowed for a current picture, slice_dawp_flag is then decoded. Description identifiers of pic_awp_flag and slice_dawp_flag may both be u(1), namely, a 1-bit unsigned integer. The value of PicAwpFlag is equal to the value of pic_awp_flag. If pic_awp_flag does not exist in a code stream, the value of PicAwpFlag is 0.

In some exemplary embodiments, only one slice header syntax element slice_dawp_flag may exist in the code stream, to indicate whether the DAWP mode is used in the current slice. A specific indication mode may be shown in Table 20 for indication with reference to pic_dawp_flag (“x” in Table 20 indicates that decoding is not needed).

TABLE 20

| pic_dawp_flag | slice_dawp_flag | Semantics |
|---|---|---|
| 0 | x | Use of the AWP mode is not allowed |
| 1 | 0 | Use of the DAWP mode is not allowed |
| 1 | 1 | Use of the DAWP mode is allowed |

pic_dawp_flag may be a binary variable, where a value of 1 indicates that the use of the DAWP mode is allowed, and a value of 0 indicates that the use of the DAWP mode is not allowed. slice_dawp_flag may be a binary variable, where a value of 1 indicates that the use of the DAWP mode is allowed, and a value of 0 indicates that the use of the DAWP mode is not allowed.

Referring to Table 20, when pic_dawp_flag is 0, it may be determined that the use of the DAWP mode is not allowed for the current slice (the DAWP mode is not allowed for an entire picture) without decoding slice_dawp_flag. When pic_dawp_flag is 1 and slice_dawp_flag is 0, it may be determined that the use of the DAWP mode is not allowed for the current slice. When both pic_dawp_flag and slice_dawp_flag are 1, it may be determined that the use of the DAWP mode is allowed for the current slice.

In an example, a decoding process of pic_dawp_flag and slice_dawp_flag is shown in Table 21.

TABLE 21

| | |
|---|---|
| pic_dawp_flag | u(1) |
| if(PicDawpFlag) { | |
| slice_dawp_flag | u(1) |
| } | |

Referring to Table 21, pic_dawp_flag is first decoded. If pic_dawp_flag indicates that the use of the DAWP mode is allowed for a current picture, slice_dawp_flag is then decoded. Description identifiers of pic_dawp_flag and slice_dawp_flag may both be u(1), namely, a 1-bit unsigned integer. The value of PicDawpFlag is equal to the value of pic_dawp_flag. If pic_dawp_flag does not exist in the code stream, the value of PicDawpFlag is 0.

In an embodiment of this application, whether to decode the foregoing high-level syntax elements (namely, the sequence header syntax element, the picture header syntax element, and the slice header syntax element) may be determined based on a picture type. For example, one or more of the foregoing high-level syntax elements may be decoded only in a specific picture type, or one or more of the foregoing high-level syntax elements may be decoded only in an unspecific picture type.

Specifically, for example, a flag bit related to dawp_flag is decoded only in the I-frame picture, or the flag bit related to dawp_flag is decoded only in the B-frame picture, or the flag bit related to dawp_flag is decoded in both the P-frame picture and the B-frame picture. For another example, a flag bit related to dawp_flag may be decoded only in the non-I frame picture.

Process 2: Decode the code stream if the AWP mode is used, and determine a syntax element related to the AWP mode, including a syntax element for determining a weight matrix and a syntax element for determining a predicted value of each part.

In an embodiment of this application, the syntax element for deriving the weight matrix includes at least one of the following syntax elements: index information for indicating the AWP mode, index information for indicating a reference weight configuration, index information for indicating a predicted angle, index information for indicating a reference weight derivation mode, index information for indicating a weight mode of the AWP mode, or index information for indicating a size of a reference weight blending area.

The index information for indicating the reference weight derivation mode may be the index information for indicating a reference weight derivation function, or may be index information for indicating a parameter of the reference weight derivation function.

Reference weight derivation functions that may be used in embodiments of this application are listed below. In the following functions, d represents a distance between a reference weight sampling point and a blending area, which may be a distance between the reference weight sampling point and a start position of the blending area, may also be a distance between the reference weight sampling point and a midpoint position of the blending area, certainly may be a distance between the reference weight sampling point and an end position of the blending area, or the like. Certainly, an offset value may also be added based on these distances. In one embodiment, a distance represented by d maybe directional. For example, if a position of the reference weight sampling point is pos, and the blending area is c, a value of d is pos-c. In this case, a negative value of d indicates a position to the left of the blending area, and a positive value of d indicates a position to the right of the blending area. Certainly, the distance represented by d may be non-directional, and then an absolute value of the distance may be obtained through calculation by using abs(pos-c).

In an embodiment of this application, the reference weight derivation function may use a linear function, for example w=s*(d+k), where s and k are parameter values of the function, and the parameter value may be a preset value, or may be indicated through code stream information.

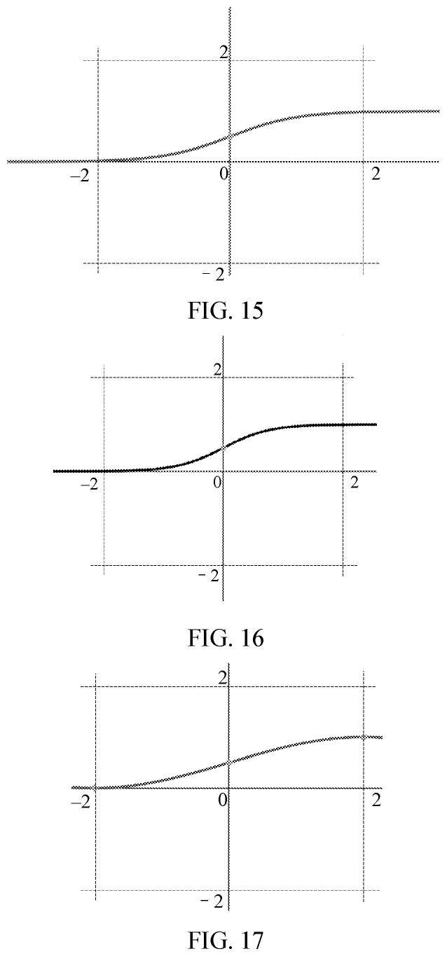

In an embodiment of this application, the reference weight derivation function may use a sigmoid function, for example:

$$w = \frac{1}{1 + {e}^{- s * d}} ,$$

where s and k are parameter values of the function, and the parameter value may be a preset value, or may be indicated through code stream information. For example, when s=2, a function picture is shown in FIG. 15, and a weight of the blending area may be set based on a function value corresponding to [−2, 2].

In an embodiment of this application, the reference weight derivation function may use a hyperbolic function. For example, a tanh function may be used: w=0.5*tanh(s*d)+0.5, where s is a parameter value of the function, and the parameter value may be a preset value, or may be indicated through the code stream information. For example, when s=1.3, a function picture is shown in FIG. 16, and a weight of the blending area may be set based on a function value corresponding to [−2, 2].

In an embodiment of this application, the reference weight derivation function may use a trigonometric function-based form. For example, a cosine function-based form may be used:

$$w = 0.5 * cos ( \frac{( s * d - 1 ) * π}{2} ) + 0.5 ,$$

where s is a parameter value of the function, and the parameter value may be a preset value, or may be indicated through the code stream information. For example, when s=0.5, a function picture is shown in FIG. 17, and a weight of the blending area may be set based on a function value corresponding to [−2, 2].

In an embodiment of this application, the reference weight derivation function may use an exponential-based function. For example, if d is less than 0,

$$w = {e}^{s 1 ( d - s 2 )} .$$

If d is greater than or equal to 0,

$$w = - \frac{1}{4 {e}^{s 1 * ( d - s 2 ) + 1}} .$$

s1 and s2 are parameter values of the function, and the parameter value may be a preset value, or may be indicated through the code stream information. For example, when s1=2 and s2=0.3465735, a weight of the blending area may be set based on a function value corresponding to [−2, 2].

In an embodiment of this application, the reference weight derivation function may use a polynomial-based function, for example, a polynomial having a second power.

In an embodiment of this application, the reference weight derivation function may perform weight derivation through a piecewise function. Different weight derivation functions are used based on a value of d. For example, when d is less than or equal to 0, a sigmoid function is used; otherwise, a linear function is used.

In an embodiment of this application, the syntax element for determining a predicted value of each part includes an index mvp_idx_n configured for determining a predicted motion vector of a reference block, and a relevant syntax element for determining to correct the motor vector. “A predicted value of each part” in this embodiment usually refers to predicted values of 2 parts, but may alternatively refer to predicted values of more parts in another embodiment of this application.

In an embodiment of this application, the relevant syntax element for determining to correct the motor vector may include a flag mvr_flag_n configured for indicating whether a motion vector needs to be corrected, an index value mvr_step_n configured for indicating a step size of motion vector correction, and an index value mvr_dir_n configured for indicating a motion vector correction direction. mvr_step_n and mvr_dir_n are configured for deriving mvd, and a motion vector mv=mvp+mvd. In another embodiment of this application, mvd may alternatively be directly obtained by decoding the code stream, and mvr_step_n and mvr_dir_n do not need to be decoded.

In an embodiment of this application, the syntax element or the part of the syntax element in the foregoing embodiment may be decoded through a variable-length code. For example, decoding processing may be performed through a k-order exponential Golomb code, a truncated unary code, a truncated binary code, or the like. In an embodiment, different parts of the syntax element in the foregoing embodiment may be respectively decoded through different variable-length codes. For example, a prefix part is decoded through the truncated unary code, and a suffix part is decoded through the truncated binary code.

In an embodiment of this application, the syntax element or the part of the syntax element in the foregoing embodiment may also be decoded through a fixed-length code.

In an embodiment of this application, the syntax element in the foregoing embodiment may also be decoded through a combination of the variable-length code and the fixed-length code. For example, the prefix part is decoded through the variable-length code, and the suffix part is decoded through the fixed-length code.

In an embodiment of this application, part of the syntax element in which a binary digit is less than a set threshold in the foregoing embodiment may be decoded through a decoding method corresponding to a context-based binary encoding method, and the remaining part is decoded through a decoding method corresponding to a bypass coding mode. For example, it is assumed that a length of the foregoing syntax element is M, a part with binary digits less than a threshold th uses context-based binary coding, and the remaining part uses a bypass mode.

In an embodiment of this application, if a total quantity of decoding modes awp_sig_mode (less than or equal to 56 AWP modes) of the AWP mode is divided into a plurality of groups, and each group includes awp_sig_divisor elements, the total quantity of groups is awp_sig_group=Ceil(awp_sig_mode/awp_sig_divisor). Therefore, the group number may be decoded through the variable-length code, and the index information of the element within a group may be decoded through the fixed-length code.

In one embodiment, a total quantity of modes awp_sig_mode obtained through decoding and a grouping mode (for example, a quantity of modes in each group or a quantity of groups) may be indicated in a high-level syntax element (for example, one or more of a sequence header, a picture header, or a header).

In an example, a quantity of the AWP modes is 56. Assuming that a total quantity of modes obtained through decoding is 56, the total quantity of modes is divided into 7 groups, and each group includes 8 modes. The group number may use a truncated unary code, and the element index within a group may use a truncated binary code. Alternatively, the group number uses context-based binary coding, and the element index in the group uses a bypass mode.

In an example, a quantity of the AWP modes is 56. Assuming that a total quantity of modes obtained through decoding is 28, the total quantity of modes is divided into 7 groups, and each group includes 4 modes. The group number may use a truncated unary code, and the element index within a group may use a truncated binary code. Alternatively, the group number uses context-based binary coding, and the element index in the group uses a bypass mode.

Process 3: Derive the rearranged mode list and a corresponding prediction mode if the rearrangement-based AWP mode is used.

In an embodiment of this application, if it is determined that the rearrangement-based AWP mode may be used, the decoder end needs to determine availability of the DAWP mode. If the DAWP mode is not available, the AWP mode is not rearranged. When the availability of the DAWP mode is determined, whether a current template (all reconstructed sampling points around the current block may be used as the template) corresponding to a current block has been reconstructed (for example, check whether a sampling point to the left of the current block is available, or check whether a sampling point above the current block is available) may be checked. Whether a size of the current block satisfies a condition (it is assumed that only a block of a specified size can use the DAWP mode) is checked, whether a color component of the current block satisfies a condition (it is assumed that only a brightness component or a chrominance component can use the DAWP mode) is checked, and the like.

In an embodiment of this application, if it is determined that a rearrangement-based AWP mode may be used, and it is determined in the foregoing mode that the DAWP mode is available, costs corresponding to each AWP mode may be calculated by traversing the Decoded AWP modes, and then a rearranged AWP mode list awp_cost_list is derived based on the costs.

In some exemplary embodiments, when the costs corresponding to each AWP mode is calculated, the following operations need to be performed (no sequential order may exist before the operations).

Operation a: Obtain the current template (the reconstructed sampling point around the current block may be used as a template).

In one embodiment, the current template may be a sampling point in N rows above (which may include upper left and/or upper right) the current block, and a width and a height of the current template are (tw0, th0).

In one embodiment, the current template may be a sampling point in M columns to the left (which may include upper left and/or lower left) of the current block, and a width and a height of the current template are (tw1, th1).

In one embodiment, the current template may be a sampling point obtained through sampling based on a fixed interval. For example, sampling is performed every other row (and/or column).

In one embodiment, the current template may simultaneously use templates on the left and the above. For example, the current template is a sampling point in one row above and one column to the left of the current block, and the width and height of the current template are the same as the width and the height of the current block.

In some exemplary embodiments, the current template may be obtained by using any combination of the foregoing methods for selecting the current template.

In some exemplary embodiments, some correction processing may be performed on the sampling point of the current template, for example, filtering, linear mapping, and non-linear mapping.

Operation b: Obtain a prediction template of each part.

In an embodiment of this application, a position of the reference block needs to be determined based on the motion vector, and then the prediction template is selected based on the position of the reference block.

In some exemplary embodiments, a position of the prediction template may correspond to a position of the current template. For example, if the current template is sampling points in N rows above (which may include upper left and/or upper right) the current block, sampling points in N rows above (which may include upper left and/or upper right) the reference block may be selected as the prediction template. If the current template is a sampling point in M columns to the left (which may include upper left and/or lower left) of the current block, a sampling point in M columns to the left (which may include upper left and/or lower left) of the reference block may be selected as the prediction template.

In some exemplary embodiments, the position of the prediction template may not correspond to the position of the current template. For example, to reduce complexity, a sampling point in the reference block may be used as the prediction template.

Specifically, the prediction template may be a sampling point located in N rows (which may include upper left and/or upper right) in the reference block, and a width and a height of the prediction template are (tw2, th2).

In one embodiment, the prediction template may be a sampling point located in M columns (which may include upper left and/or lower left) in the reference block, and a width and a height of the prediction template are (tw3, th3).

In one embodiment, the prediction template may also be obtained by sampling based on a fixed interval. For example, sampling is performed every other row (and/or column).

In one embodiment, the prediction template may simultaneously use templates on the left and on the above. For example, the prediction template is a sampling point in one row above and one column to the left of the reference block, and the width and the height of the prediction template are the same as the width and the height of the reference block. Alternatively, the prediction template may be a sampling point located in the first row and the first column in the reference block, and the width and the height of the prediction template are the same as the width and the height of the reference block.

In some exemplary embodiments, the prediction template may be obtained by using any combination of the foregoing methods for selecting the prediction template.

In some exemplary embodiments, some correction processing may be performed on the sampling point of the prediction template, for example, filtering, linear mapping, and non-linear mapping.

In some exemplary embodiments, the motion vector of the prediction template may be calculated based on a relative position between the prediction template and the reference block, and motion compensation is performed to derive a predicted value. In one embodiment, if the motion vector is a sub-pixel, interpolation filtering may be performed, and different interpolation filters may be used, for example, a bilinear compensation interpolation filter is used.

In an embodiment of this application, a process of deriving the predicted value in the AWP mode is as follows. Assuming that a motion vector cu_mv of the current block is (mv_x, mv_y), and an upper left corner of the prediction template is in one row above the reference block having the same width with the current block, namely, the width and the height (tpl_w, tpl_h) are (cu_w, 1), a motion vector tpl_mv from the current block to the prediction template is (mv_x, mv_y−1), and the predicted value of the prediction template may be derived based on coordinates (cu_x, cu_y) of the current block and tpl_mv. tpl is the prediction template, tpl_w is the width of the prediction template, tpl_h is the height of the prediction template, and cu_w is the width of the current block.

In an embodiment of this application, a process of deriving the predicted value in an SAWP mode is as follows. Assuming that an intra prediction mode of the current block is intra_mode, and an upper left corner of the prediction template is in one row above the reference block having the same width as the current block, namely, the width and the height (tpl_w,tpl_h) are (cu_w, 1), an intra predicted value of the current template is derived through reconstructed pixels on the above and to the left of a current prediction template tpl based on the intra prediction mode intra_mode. tpl_w is the width of the prediction template, tpl_h is the height of the prediction template, and cu_w is the width of the current block.

Operation c: Derive a template weight.

In some exemplary embodiments, the weight of the prediction template may be derived based on a weight derivation method in the AWP mode, where a relative position relationship between the prediction template and the reference block needs to be considered.

In some exemplary embodiments, a weight threshold may be set, a template weight greater than or equal to the weight threshold is set to 1, and a template weight less than the weight threshold is set to 0.

In some exemplary embodiments, the reference weight configuration and the weight prediction angle that correspond to the prediction template may be obtained. Based on the above, a central position cp of a reference weight blending area is then determined. Then, a position tp of a sampling point corresponding to the prediction template after projection based on the weight prediction angle is calculated. If tp<cp (namely, a projection position is to the left of cp), a template weight of the sampling point corresponding to the prediction template is set to 0; otherwise, the template weight is set to 1.

In some exemplary embodiments, the template weight may be pre-initialized, and does not need to be repeatedly derived.

Operation d: Derive a weighted prediction template.

After the template weight of the prediction template is obtained through calculation, a weighted combination may be performed on each part of the prediction template through the template weight, to obtain the weighted prediction template.

Operation e: Calculate costs.

In some exemplary embodiments, an SAD between the weighted prediction template and the current template may be calculated, or an SSE between the weighted prediction template and the current template may be calculated, or an MR-SAD between the weighted prediction template and the current template may be calculated, which is used as the costs of the AWP mode.

In one embodiment, when the costs are calculated, only a part in which a sampling point difference is less than a threshold may be collected through statistics.

In some exemplary embodiments, after the costs of the AWP mode are obtained through calculation, the AWP modes may be sorted in ascending order of costs, to obtain a rearranged AWP mode list awp_cost_list.

In one embodiment, when sorting is performed in ascending order of costs, the sorting may be stopped if a quantity of sorted AWP modes reaches a set quantity (for example, a quantity of Decoded AWP modes).

In an embodiment of this application, after the rearranged AWP mode list awp_cost_list is derived, a mode in the rearranged AWP mode list corresponding to mode index information obtained through decoding is a mode finally configured for performing weighted prediction, and is denoted as final_awp_mode.

Process 4: Derive a weight matrix based on the derived prediction mode, to perform weighted prediction.

In an embodiment of this application, after a mode final_awp_mode for performing weighted prediction is determined, a weight matrix may be derived based on final_awp_mode, and then weighted prediction is performed based on the weight matrix to obtain a predicted value.

The technical solution in the embodiments of this application is not only applicable to rearrangement processing of the AWP mode, but also applicable to the rearrangement processing of the SAWP mode.

An apparatus embodiment of this application is described below, which may be configured for performing the method in the foregoing embodiment of this application. For details not disclosed in the apparatus embodiment of this application, reference may be made to the foregoing method embodiment of this application.

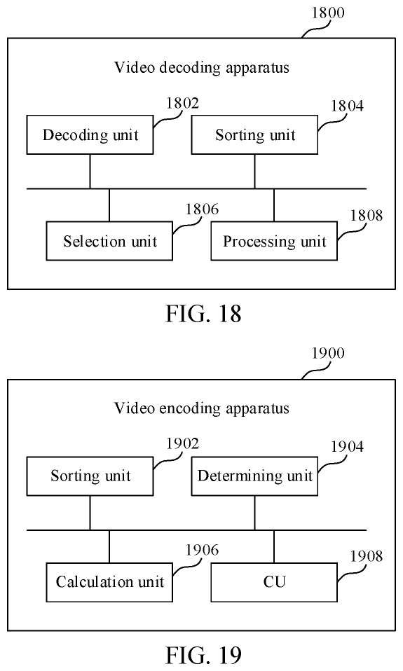

FIG. 18 is a block diagram of a video decoding apparatus according to an embodiment of this application. The video decoding apparatus may be arranged in a device with a computing processing function, for example, may be arranged in a terminal device or a server.

Referring to FIG. 18, a video decoding apparatus 1800 according to an embodiment of this application includes a decoding unit 1802, a sorting unit 1804, a selection unit 1806, and a processing unit 1808.

The decoding unit 1802 is configured to decode a video code stream, to obtain mode index information for a rearranged mode list. The sorting unit 1804 is configured to sort, in ascending order of costs of a plurality of AWP modes used for a current block, the plurality of AWP modes, to obtain the rearranged mode list. The selection unit 1806 is configured to select a corresponding AWP mode from the rearranged mode list based on the mode index information, and derive a weight matrix of the current block based on the selected AWP mode. The processing unit 1808 is configured to perform weighted prediction based on the weight matrix, to obtain a predicted value corresponding to the current block.

In some embodiments of this application, based on the foregoing solution, the sorting unit 1804 is configured to sort the plurality of AWP modes in ascending order of the costs of the plurality of AWP modes if it is determined, based on the index flag bit, that use of a rearrangement-based AWP mode is allowed for the current block, to obtain the rearranged mode list.

In some embodiments of this application, based on the foregoing solution, the index flag bit includes at least one of the following flag bits: a sequence header flag bit included in sequence header information, a picture header flag bit included in picture header information, and a slice header flag bit included in slice header information, the sequence header flag bit being configured for indicating whether the use of the rearrangement-based AWP mode is allowed for a current sequence, the picture header flag bit being configured for indicating whether the use of the rearrangement-based AWP mode is allowed for a current picture, and the slice header flag bit being configured for indicating whether the use of the rearrangement-based AWP mode is allowed for a current slice.

In some embodiments of this application, based on the foregoing solution, the index flag bit includes one or more flag bits, different values of the one or more flag bits being configured for indicating whether use of the AWP mode is allowed for a corresponding coding block, and whether the use of the rearrangement-based AWP mode is allowed when the use of the AWP mode is allowed.

In some embodiments of this application, based on the foregoing solution, the decoding unit 1802 is configured to: decode the index flag bit from the video code stream if a video picture frame type is a specified type; or decode the index flag bit from the video code stream if the video picture frame type is a non-specified type.

In some embodiments of this application, based on the foregoing solution, the decoding unit 1802 is further configured to decode, from the video code stream, a syntax element for deriving a weight matrix and a syntax element for determining a plurality of predicted values if the AWP mode is used for the current block.

In some embodiments of this application, based on the foregoing solution, the syntax element for deriving the weight matrix includes at least one of the following syntax elements: index information for indicating the AWP mode, index information for indicating a reference weight configuration, index information for indicating a predicted angle, index information for indicating a reference weight derivation mode, index information for indicating a weight mode of the AWP mode, or index information for indicating a size of a reference weight blending area.

In some embodiments of this application, based on the foregoing solution, the syntax element for deriving the weight matrix includes:
index information for indicating the AWP mode; or
index information for indicating a reference weight derivation mode and index information for indicating the AWP mode; or
the index information for indicating the reference weight derivation mode, index information for indicating a reference weight configuration, and index information for indicating a predicted angle; or
index information for indicating a weight mode of the AWP mode; or
the index information for indicating the reference weight configuration and the index information for indicating the predicted angle.

In some embodiments of this application, based on the foregoing solution, the syntax element for determining the plurality of predicted values includes at least one of the following syntax elements: index information for determining a predicted motion vector of a reference block, a syntax element for determining to correct a motion vector, or a syntax element for determining an intra prediction mode,
the syntax element for determining to correct the motion vector including: index information for indicating whether the motion vector needs to be corrected, index information for indicating a step size of motion vector correction, and index information for indicating a motion vector correction direction; or
index information for indicating whether the motion vector needs to be corrected and index information for indicating a motion vector difference.

In some embodiments of this application, based on the foregoing solution, part or all of binary digits of the syntax element are decoded through a variable-length code; or
part or all of the binary digits of the syntax element are decoded through a fixed-length code; or
different parts of the binary digits of the syntax element are respectively decoded through different variable-length codes; or
part or all of the binary digits of the syntax element are decoded through a combination of the variable-length code and the fixed-length code; or
part of the syntax element in which a binary digit is less than a set threshold is decoded through a decoding method corresponding to a context-based binary encoding method, and the remaining part are decoded through a decoding method corresponding to a bypass coding mode.

In some embodiments of this application, based on the foregoing solution, the decoding part or all of the binary digits of the syntax element through a combination of the variable-length code and the fixed-length code includes: decoding, through the variable-length code, index information in the mode index information for indicating a group number, and decoding, through the fixed-length code, index information in the mode index information for indicating an element within a group, if a quantity of the decoded AWP modes is divided into a plurality of groups based on a set grouping manner.

In some embodiments of this application, based on the foregoing solution, the video decoding apparatus further includes: an obtaining unit, configured to obtain, for each of the plurality of AWP modes, a current template corresponding to the current block, and obtain a prediction template corresponding to a reference block of the current block; a weight derivation unit, configured to determine a template weight corresponding to the prediction template based on a weight derived from each AWP mode; a weighted calculation unit, configured to calculate a weighted prediction template based on the template weight and the prediction template; and a cost calculation unit, configured to calculate a cost of each AWP mode based on the weighted prediction template and the current template.

In some embodiments of this application, based on the foregoing solution, the current template corresponding to the current block includes at least one of the following sampling points:
a sampling point located in a set row above a current block;
a sampling point located in a set column to a left of the current block;
a sampling point obtained through sampling of a sampling point adjacent to the current block based on a set interval; or
the sampling points located in the set row above the current block and in the set column to the left of the current block.

In some embodiments of this application, based on the foregoing solution, the prediction template corresponding to the reference block of the current block includes at least one of the following sampling points:
a sampling point located in a set row above the reference block;
a sampling point located in a set column to a left of the reference block;
a sampling point in the set row within the reference block;
a sampling point within the reference block in the set column;
a sampling point obtained through sampling of a sampling point adjacent to the reference block based on the set interval;
a sampling point obtained through sampling of the sampling point within the reference block based on the set interval;
the sampling points located in the set row above the reference block and in the set column to the left of the reference block; or
the sampling points in the set row above the reference block and in the set column to the left of the reference block.

In some embodiments of this application, based on the foregoing solution, the obtaining unit is further configured to perform at least one of the following processing modes: performing correction processing on a sampling point in the current template, and performing correction processing on a sampling point in the prediction template, the correction processing including one or more of filtering processing, linear mapping processing, and non-linear mapping processing.

In some embodiments of this application, based on the foregoing solution, the weight derivation unit is further configured to: set the template weight to 1 for the AWP mode in which a derived weight is greater than a weight threshold, and set the template weight to 0 for the AWP mode in which a derived weight is less than the weight threshold; or
set the template weight to 0 if a position of a sampling point corresponding to the prediction template after being projected based on a weight prediction angle is located on a left side of a central position of a blending area; otherwise, set the template weight to 1.

In some embodiments of this application, based on the foregoing solution, the cost calculation unit is configured to calculate a sum of absolute differences (SAD), or a sum of squared differences (SSD), or a mean-reduced SAD (MR-SAD) between the weighted prediction template and the current template, and use the SAD, the SSD, or the MR-SAD as the cost of each AWP mode.

In some embodiments of this application, based on the foregoing solution, the cost calculation unit is configured to calculate an SAD, or an SSD, or an MR-SAD between target sampling points where a difference between the sampling points in the weighted prediction template and the current template is less than a set threshold.

In some embodiments of this application, based on the foregoing solution, the sorting unit 1804 is configured to stop the sorting if a quantity of AWP modes that are sorted in ascending order of the costs reaches a set quantity, the set quantity being less than or equal to a total quantity of the AWP modes.

In some embodiments of this application, based on the foregoing solution, the decoding unit 1802 is configured to use, as the mode index information, at least one of the following index information obtained through decoding of the video code stream: index information for indicating the AWP mode, index information for indicating a reference weight configuration, index information for indicating a predicted angle, index information for indicating a reference weight derivation mode, or index information for indicating a weight mode of the AWP mode,
the rearranged mode list being a mode list obtained by rearranging one or more pieces of index information included in the mode index information.

FIG. 19 is a block diagram of a video encoding apparatus according to an embodiment of this application. The video encoding apparatus may be arranged in a device with a computing processing function, for example, may be arranged in a terminal device or a server.

Referring to FIG. 19, a video encoding apparatus 1900 according to an embodiment of this application includes a sorting unit 1902, a determining unit 1904, a calculation unit 1906, and a CU 1908.

The sorting unit 1902 is configured to sort, in ascending order of costs of a plurality of AWP modes used for a current block, the plurality of AWP modes, to obtain the rearranged mode list. The determining unit 1904 is configured to determine mode index information based on the rearranged mode list and a selected AWP mode. The calculation unit 1906 is configured to derive a weight matrix of the current block based on the selected AWP mode. The CU 1908 is configured to perform weighted prediction based on the weight matrix, to obtain a predicted value corresponding to the current block, perform encoding processing on the current block based on the predicted value, and encode the mode index information in a video code stream.

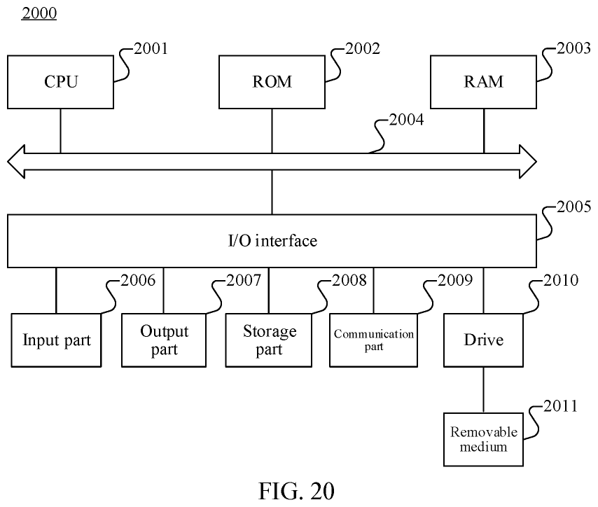

FIG. 20 is a schematic structural diagram of a computer system adapted to implement an electronic device according to an embodiment of this application. The electronic device may be the video decoding apparatus or the video encoding apparatus in the foregoing embodiments.

A computer system 2000 of an electronic device shown in FIG. 20 is merely an example, and does not impose any limitation on a function and use scope of this embodiment of this application.

As shown in FIG. 20, the computer system 2000 may include a central processing unit (CPU) 2001, which may perform various suitable actions and processes based on a program stored in a read-only memory (ROM) 2002 or a program loaded from a storage part 2008 into a random access memory (RAM) 2003, for example, perform the method in the foregoing embodiments. The RAM 2003 further has various programs and data required for system operation stored therein. The CPU 2001, the ROM 2002, and the RAM 2003 are connected to each other through a bus 2004. An input/output (I/O) interface 2005 is also connected to the bus 2004.

The following components may be connected to the I/O interface 2005: an input part 2006 including a keyboard, a mouse, or the like; an output part 2007 including a cathode ray tube (CRT), a liquid crystal display (LCD), a speaker, or the like; a storage part 2008 including a hard disk, or the like; and a communication part 2009 including a network interface card such as a local area network (LAN) card and a modem. The communication part 2009 performs communication processing through a network such as the Internet. A drive 2010 is also connected to the I/O interface 2005 as required. A removable medium 2011, such as a magnetic disk, an optical disc, a magneto-optical disk, or a semiconductor memory is installed on the drive 2010 as required, so that a computer program read from the removable medium is installed into the storage portion 2008 as required.

Particularly, according to the embodiments of this application, the processes described above with reference to the flowcharts may be implemented as a computer software program. For example, the embodiments of this application include a computer program product, the computer program product including a computer program carried on a computer-readable medium, the computer program being configured to perform the methods shown in the flowcharts. In such an embodiment, the computer program may be downloaded and installed from a network through the communication part 2009, and/or installed from the removable medium 2011. When the computer program is executed by the CPU 2001, various functions defined in the system of this application are executed.

The computer-readable medium shown in the embodiments of this application may be a computer-readable signal medium or a computer-readable storage medium or any combination of the two media. The computer-readable storage medium may be, for example, but is not limited to, an electric, magnetic, optical, electromagnetic, infrared, or semi-conductive system, apparatus, or device, or any combination of the above. A more specific example of the computer-readable storage medium may include but is not limited to: an electrical connection having one or more wires, a portable computer disk, a hard disk, a RAM, a ROM, an erasable programmable ROM (EPROM), a flash memory, an optical fiber, a portable compact disk ROM (CD-ROM), an optical storage device, a magnetic storage device, or any appropriate combination of the above. In this application, the computer-readable storage medium may be any tangible medium that includes a computer program or has a computer program stored therein. The computer program may be used by or used in combination with an instruction execution system, an apparatus, or a device. In this application, the computer-readable signal medium may include a data signal transmitted in a baseband or as a part of a carrier, and carries a computer-readable computer program. Such a transmitted data signal may have various forms, including but not limited to an electromagnetic signal, an optical signal, or any proper combination thereof. The computer-readable signal medium may alternatively be any computer-readable medium other than a computer-readable storage medium. The computer-readable medium may transmit, propagate, or transmit a program that is used by or used in conjunction with an instruction execution system, an apparatus, or a device. The computer program included in the computer-readable medium may be transmitted by using any suitable medium, including but not limited to a wireless medium, a wired medium, or the like, or any suitable combination of the above.

Flowcharts and block diagrams in the accompanying drawings illustrate possible system architectures, functions and operations that may be implemented by a system, a method, and a computer program product according to various embodiments of this application. Each block in the flowcharts or the block diagrams may represent a module, a program segment, or a part of code. The module, the program segment, or the part of the code includes one or more executable instructions configured for implementing a specified logical function. In some alternative implementations, functions annotated in the boxes may also be executed in an order different from that annotated in the accompanying drawings. For example, two blocks shown in succession may actually be performed substantially in parallel, or may sometimes be performed in a reverse order, which depends on the functions involved. Each block of the block diagrams or the flowcharts and combinations of blocks in the block diagrams or the flowcharts may be implemented by a dedicated hardware-based system configured to perform specified functions or operations, or may be implemented by a combination of dedicated hardware and a computer program. The involved units described in the embodiments of this application may be implemented by software or hardware, and the described units may alternatively be arranged in a processor. Names of the units do not constitute a limitation on the units in a specific case.

According to another aspect, this application further provides a computer-readable medium. The computer-readable medium may be included in the electronic device in the foregoing embodiments, or may exist alone without being installed into the electronic device. The foregoing computer-readable medium carries one or more computer programs, the one or more computer programs, when executed by the electronic device, causing the electronic device to implement the methods described in the foregoing embodiments.

Although a plurality of modules or units of a device configured to perform actions are mentioned in the foregoing detailed description, such division is not mandatory. Actually, according to the implementations of this application, the features and functions of two or more modules or units described above may be specifically implemented in one module or unit. On the contrary, the features and functions of one module or unit described above may be further divided to be embodied by a plurality of modules or units.

According to the foregoing descriptions of the implementations, a person skilled in the art may readily understand that the exemplary implementations described herein may be implemented by software, or may be implemented by combining software and necessary hardware. Therefore, the technical solutions according to the implementations of this application may be embodied in a form of a software product. The software product may be stored in a non-volatile storage medium (which may be a CD-ROM, a USB flash drive, a removable hard disk, or the like) or on a network, including several instructions for causing an electronic device to perform the method according to the implementations of this application. For example, the electronic device may be a video decoding apparatus, and the video decoding apparatus may perform the video decoding method shown in FIG. 13. For another example, the electronic device may be a video encoding apparatus, and the video encoding apparatus may perform the video encoding method shown in FIG. 14.

A person skilled in the art may easily figure out another implementation of this application after considering the specification and practicing the implementations disclosed herein. This application is intended to cover any variations, uses, or adaptive changes of this application. These variations, uses, or adaptive changes follow the general principles of this application and include common general knowledge or common technical means in the art, which are not disclosed in this application.

This application is not limited to the precise structures described above and shown in the accompanying drawings, and various modifications and changes may be made without departing from the scope of this application. The scope of this application is subject only to the appended claims.

What is claimed is:

1. A video decoding method, comprising:
decoding a video code stream, to obtain mode index information for a rearranged mode list;
sorting a plurality of angular weighted prediction (AWP) modes used for a current block in accordance with an ascending order of cost of the plurality of AWP modes, to obtain the rearranged mode list;
selecting a corresponding AWP mode from the rearranged mode list based on the mode index information;
deriving a weight matrix of the current block based on the selected AWP mode; and
performing weighted prediction based on the weight matrix, to obtain a predicted value corresponding to the current block.

2. The video decoding method according to claim 1, wherein the sorting a plurality of angular weighted prediction (AWP) modes used for a current block in accordance with an ascending order of cost of the plurality of AWP modes, to obtain the rearranged mode list comprises:
decoding an index flag bit comprised in the video code stream; and
sorting the plurality of AWP modes in the ascending order of the costs of the plurality of AWP modes to obtain the rearranged mode list in accordance with a determination that use of a rearrangement-based AWP mode is allowed for the current block based on the index flag bit.

3. The video decoding method according to claim 2, wherein the index flag bit comprises at least one of the following flag bits:
a sequence header flag bit comprised in sequence header information, a picture header flag bit comprised in picture header information, and a slice header flag bit comprised in slice header information,
the sequence header flag bit being configured for indicating whether the use of the rearrangement-based AWP mode is allowed for a current sequence, the picture header flag bit being configured for indicating whether the use of the rearrangement-based AWP mode is allowed for a current picture, and the slice header flag bit being configured for indicating whether the use of the rearrangement-based AWP mode is allowed for a current slice.

4. The video decoding method according to claim 2, wherein the index flag bit comprises one or more flag bits,
different values of the one or more flag bits being configured for indicating whether use of the AWP mode is allowed for a corresponding coding block, and whether the use of the rearrangement-based AWP mode is allowed when the use of the AWP mode is allowed.

5. The video decoding method according to claim 2, wherein the decoding an index flag bit comprised in the video code stream comprises:
decoding the index flag bit from the video code stream in accordance with a determination that a video picture frame type is a specified type or a non-specified type.

6. The video decoding method according to claim 1, further comprising:
decoding, from the video code stream, a first syntax element for deriving the weight matrix and a second syntax element for determining a plurality of predicted values when the AWP mode is used for the current block.

7. The video decoding method according to claim 6, wherein the first syntax element for deriving the weight matrix comprises at least one of the following syntax elements:
index information for indicating the AWP mode, index information for indicating a reference weight configuration, index information for indicating a predicted angle, index information for indicating a reference weight derivation mode, index information for indicating a weight mode of the AWP mode, or index information for indicating a size of a reference weight blending area.

8. The video decoding method according to claim 6, wherein the first syntax element for deriving the weight matrix comprises:
index information for indicating the AWP mode; or
index information for indicating a reference weight derivation mode and index information for indicating the AWP mode; or
the index information for indicating the reference weight derivation mode, index information for indicating a reference weight configuration, and index information for indicating a predicted angle; or
index information for indicating a weight mode of the AWP mode; or
the index information for indicating the reference weight configuration and the index information for indicating the predicted angle.

9. The video decoding method according to any claim 6, wherein the second syntax element for determining the plurality of predicted values comprises at least one of the following syntax elements: index information for determining a predicted motion vector of a reference block, a syntax element for determining to correct a motion vector, or a syntax element for determining an intra prediction mode,
the syntax element for determining to correct the motion vector comprising: index information for indicating whether the motion vector needs to be corrected, index information for indicating a step size of motion vector correction, and index information for indicating a motion vector correction direction; or
index information for indicating whether the motion vector needs to be corrected and index information for indicating a motion vector difference.

10. The video decoding method according to claim 6, wherein the decoding of each of the first syntax element and the second syntax element comprises:
decoding part or all of binary digits of the syntax element through a variable-length code; or
decoding part or all of the binary digits of the syntax element through a fixed-length code; or
respectively decoding different parts of the binary digits of the syntax element through different variable-length codes; or
decoding part or all of the binary digits of the syntax element through a combination of the variable-length code and the fixed-length code; or
decoding, through a decoding method corresponding to a context-based binary encoding method, part of the syntax element in which a binary digit is less than a set threshold, and decoding the remaining part through a decoding method corresponding to a bypass coding mode.

11. The video decoding method according to claim 10, wherein the decoding part or all of the binary digits of the syntax element through a combination of the variable-length code and the fixed-length code comprises:
decoding, through the variable-length code, index information in the mode index information for indicating a group number, and decoding, through the fixed-length code, index information in the mode index information for indicating an element within a group, if a quantity of the decoded AWP modes is divided into a plurality of groups based on a set grouping manner.

12. The video decoding method according to claim 1, wherein before the sorting of the plurality of AWP modes, the method further comprises:
obtaining, for each of the plurality of AWP modes, a current template corresponding to the current block and a prediction template corresponding to a reference block of the current block;
determining a template weight corresponding to the prediction template based on a weight derived from the AWP mode;
calculating a weighted prediction template based on the template weight and the prediction template; and
calculating a cost of the AWP mode based on the weighted prediction template and the current template.

13. The video decoding method according to claim 12, wherein the current template comprises at least one of the following sampling points:
a sampling point located in a preset row above a current block;
a sampling point located in a preset column to a left of the current block;
a sampling point obtained through sampling of a sampling point adjacent to the current block based on a set interval; or
the sampling points located in the set row above the current block and in the set column to the left of the current block.

14. The video decoding method according to claim 12, wherein the prediction template comprises at least one of the following sampling points:
a sampling point located in a set row above the reference block;
a sampling point located in a set column to a left of the reference block;
a sampling point in the set row within the reference block;
a sampling point within the reference block in the set column;
a sampling point obtained through sampling of a sampling point adjacent to the reference block based on the set interval;
a sampling point obtained through sampling of the sampling point within the reference block based on the set interval;
the sampling points located in the set row above the reference block and in the set column to the left of the reference block; or
the sampling points in the set row above the reference block and in the set column to the left of the reference block.

15. The video decoding method according to claim 12, further comprising at least one of the following processing modes: performing correction processing on a sampling point in the current template, and performing correction processing on a sampling point in the prediction template,
the correction processing comprising one or more of filtering processing, linear mapping processing, and non-linear mapping processing.

16. The video decoding method according to claim 12, wherein the determining a template weight corresponding to the prediction template based on a weight derived from each AWP mode comprises:
setting the template weight to 1 for the AWP mode in which a derived weight is greater than a weight threshold, and setting the template weight to 0 for the AWP mode in which a derived weight is less than the weight threshold; or
setting the template weight to 0 if a position of a sampling point corresponding to the prediction template after being projected based on a weight prediction angle is located on a left side of a central position of a blending area; otherwise, setting the template weight to 1.

17. The video decoding method according to claim 1, wherein the sorting of the plurality of AWP modes to obtain the rearranged mode list comprises:
stopping the sorting when a quantity of AWP modes that are sorted in the ascending order of the costs reaches a preset quantity, the set quantity being less than or equal to a total quantity of the AWP modes.

18. The video decoding method according to claim 1, wherein the decoding a video code stream, to obtain mode index information for a rearranged mode list comprises:
using, as the mode index information, at least one of the following index information obtained through decoding of the video code stream: index information for indicating the AWP mode, index information for indicating a reference weight configuration, index information for indicating a predicted angle, index information for indicating a reference weight derivation mode, or index information for indicating a weight mode of the AWP mode,
the rearranged mode list being a mode list obtained by rearranging one or more pieces of index information comprised in the mode index information.

19. An electronic device, comprising:
one or more processors; and
a memory, configured to store one or more computer programs, the one or more computer programs, when executed by the one or more processors, causing the electronic device to implement a video decoding method including:
decoding a video code stream, to obtain mode index information for a rearranged mode list;
sorting a plurality of angular weighted prediction (AWP) modes used for a current block in accordance with an ascending order of cost of the plurality of AWP modes, to obtain the rearranged mode list;
selecting a corresponding AWP mode from the rearranged mode list based on the mode index information;
deriving a weight matrix of the current block based on the selected AWP mode; and
performing weighted prediction based on the weight matrix, to obtain a predicted value corresponding to the current block.

20. A non-transitory computer-readable medium storing a video code stream, the video code stream being configured to be decoded by a video decoding method, the video decoding method including:
decoding the video code stream, to obtain mode index information for a rearranged mode list;
sorting a plurality of angular weighted prediction (AWP) modes used for a current block in accordance with an ascending order of cost of the plurality of AWP modes, to obtain the rearranged mode list;
selecting a corresponding AWP mode from the rearranged mode list based on the mode index information;
deriving a weight matrix of the current block based on the selected AWP mode; and
performing weighted prediction based on the weight matrix, to obtain a predicted value corresponding to the current block.
